(19) United States
(12) Patent Application Publication
(10) Pub. No.: US 2024/0419758 A1
(43) Pub. Date: Dec. 19, 2024

(54) Extreme-Throughput Fast-Fourier-Transform (FFT) Via Multi-Stage Tensor Processing

(71) Applicant: Flex Logix Technologies, Inc., Mountain View, CA (US)

(72) Inventors: Frederick A. Ware, Los Altos Hills, CA (US); Cheng C. Wang, Los Altos, CA (US); Niken Jariwala, Mountain View, CA (US)

(21) Appl. No.: 18/745,051

(22) Filed: Jun. 17, 2024

Related U.S. Application Data
(60) Provisional application No. 63/521,693, filed on Jun. 18, 2023.

(51) Int. Cl. G06F 17/14

(52) U.S. Cl. CPC G06F 17/142

(57) ABSTRACT

Multiply-accumulate processors within a tensor processing unit simultaneously execute, in each of a sequence of multiply-accumulate cycles, respective complex-data multiply operations using a shared complex data operand and respective fast-Fourier-transform parameters, each of the multiply-accumulate processors applying a new complex input data operand and respective fast-Fourier-transform parameter in each successive multiply-accumulate cycle to accumulate, as a component of a resultant fast Fourier transform, a respective sum of complex multiplication products.

### CROSS REFERENCE TO RELATED APPLICATIONS

This application hereby incorporates by reference and claims the filing-date benefit of U.S. provisional application No. 63/521,693 filed Jun. 18, 2023.

### DRAWINGS

The various embodiments disclosed herein are illustrated by way of example, and not by way of limitation, in the figures of the accompanying drawings and in which like reference numerals refer to similar elements and in which:

FIG. 1A illustrates an embodiment of an integrated-circuit fast-Fourier-transform (FFT) engine having broadcast-data tensor processing units (TPUs) grouped/clustered within processing tiles and interconnected to one another and to on-die memory;

FIG. 1B illustrates an overview of a fast-fourier-transform-4K (FFT-4K) TPU configuration implemented within the tiled TPU architecture (multiple TPUs per tile) of FIG. 1A;

FIG. 2 illustrates an embodiment of a full, three-tile (48 TPU) implementation of the FFT-4K hardware;

FIG. 3 illustrates an alternate implementation of the FFT-4K hardware that requires only one tile (e.g., 16 TPUs)

FIG. 4 shows an exemplary decomposition of an FFT-4K into three sets of FFT-16;

FIG. 5 illustrates exemplary physical data steering details for the three FFT-16 operations discussed in reference to FIG. 4;

FIG. 6 presents an exemplary summary of the FFT execution interval as a function of the number of execution tiles (each tile contains 16 TPU pipelines in the depicted example);

FIGS. 7-10 illustrate examples of procedural code that may be used to implement or model the FFT-4K approach described in reference to FIGS. 1A, 1B and 2-6;

FIG. 11 illustrates exemplary decomposition of an FFT-2K into two sets of FFT-16 and one set of FFT-8;

FIG. 12 illustrates exemplary data steering details for the FFT-2K sub-operations described above;

FIG. 13 illustrates exemplary data steering details for the FFT-1K operations;

FIGS. 14-17 illustrate exemplary procedural code implementations/modeling of the FFT-{2K, 1K, 512, 256} hardware engines;

FIGS. 18-21 present transport details for FFT-4K operation—specifically the input/output requirements and the internal wiring needed to move results between TPU execution blocks, matching the compute bandwidth and input/output bandwidth;

FIG. 22 illustrates an exemplary transport overview for the 1-Tile FFT-engine implementation, showing how compute and I/O bandwidth are matched;

FIG. 23 illustrates exemplary sequencing of an FFT-4K operation for the 1-Tile FFT implementation;

FIG. 24 illustrates exemplary transport detail for the 1-Tile FFT implementation;

FIG. 25 illustrates exemplary transport path detail for the sub-operations of FFT Stage U;

FIG. 26 illustrates exemplary timing detail for the sub-operations of Stage U;

FIG. 27 illustrates an exemplary implementation of a transpose box applied to adjust the order of the streaming data;

FIG. 28 illustrates exemplary timing for the write/read-alternated SRAM block shown in FIG. 27;

FIG. 29 illustrates an embodiment of another transpose box used to adjust the order of the streaming data;

FIG. 30 illustrates exemplary timing for the two static random access memory (SRAM) blocks discussed in reference to FIG. 29;

FIG. 31 illustrates an embodiment of the B0/B1/B2/B3 transpose box used to adjust the order of the streaming data;

FIG. 32 illustrates exemplary timing for the two per-SWMD-channel (single-weight, multiple-data channel), per-TPU SRAM blocks shown in FIG. 31;

FIG. 33 illustrates an exemplary architecture of the Winograd (WGD) Z-to-Y conversion box;

FIG. 34 presents an exemplary pseudocode listing corresponding to the Winograd Z-to-Y conversion box shown in FIG. 33, showing five nested loops implemented by the hardware set to carry out the conversion;

FIG. 35 illustrates another exemplary architecture for the Winograd (WGD) Z-to-Y conversion box; and

FIG. 36 illustrates additional detail with respect to a C2 transpose box embodiment.

### DETAILED DESCRIPTION

In various embodiments herein multiply-accumulate (MAC) processors within a plurality of tensor processing units (TPUs) simultaneously execute, in each of a sequence of MAC cycles, respective multiply operations using a shared (common) input data operand and respective fast-Fourier transform (FFT) operands, each of the MAC processors applying a new shared input data operand and respective FFT operand in each successive MAC cycle to accumulate, as a component of an output FFT result, a respective sum-of-multiplication-products.

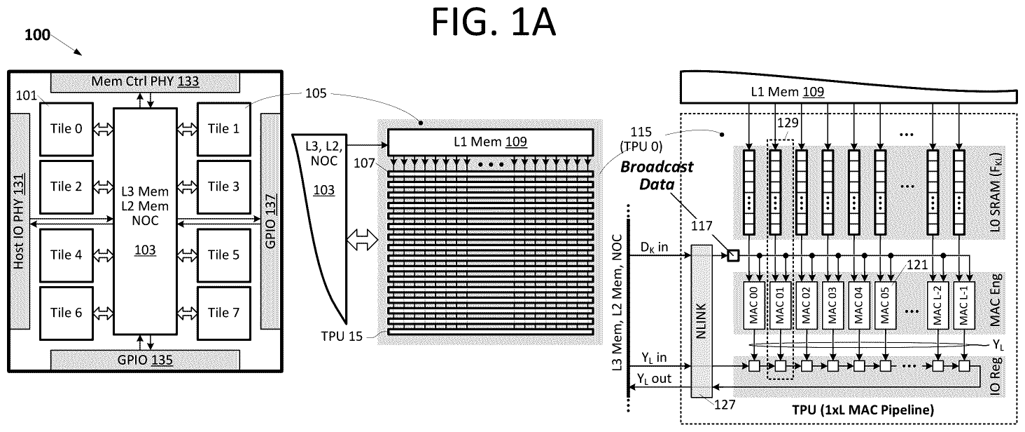

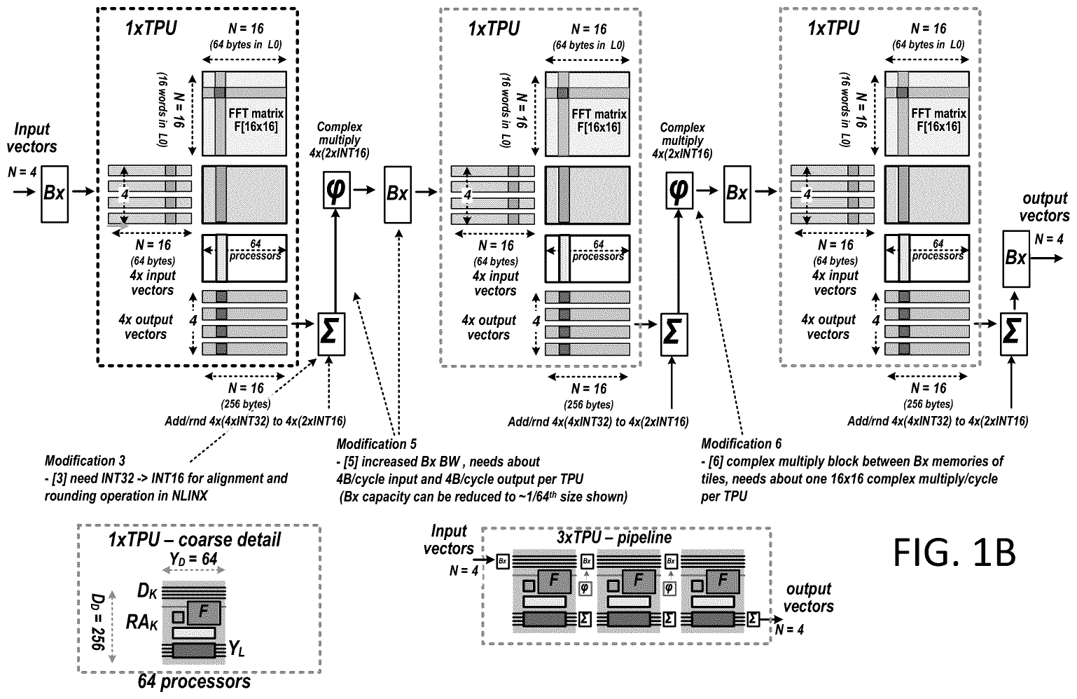

FIG. 1A illustrates an embodiment of an integrated-circuit FFT engine 100 (“FFT IC”) having broadcast-data TPUs grouped/clustered within processing tiles 101 and interconnected to one another, on-die memory and various physical signaling interfaces via a network-on-chip interconnect 103. In the depicted implementation, each of the processing tiles 101—shown for example in detail view 105—includes sixteen TPUs 107 (a ×16 TPU cluster) coupled to receive FFT operand values (e.g., FFT parameters) from a shared local (tile-resident) memory 109 referred to herein as level-one (L1) memory. Referring to the exemplary detail at 115, each TPU 107 includes a broadcast data register 117 and high-speed/low-latency FFT operand storage 119 (referred to herein as a level-zero (L0) memory), together with a bank of ‘L’ multiply-accumulate units 121 (collectively implementing a MAC engine 123), input/output (I/O) shift register 125, and linking logic 127 (“NLINK”), the latter for interfacing to the broadcast data register and I/O shift register to NOC 107 and thus to the progressively larger level-two and level-three memories (L2 and L3) and signaling PHYs (physical signaling interfaces). The collective circuit block shown at 129, including an individual MAC unit 121 and the L0 memory stripe (column) and I/O register element coupled to that MAC unit, is referred to herein as a MAC processor, with the TPU including a total of L such MAC processors implementing a collective parallel MAC pipeline. In some contexts, the MAC units themselves may be referred to (or viewed as) constituting MAC processors, with the L0 memory and/or shift-out register comprising processor-support circuitry. In any case, broadcast data register 117 outputs a sequence of shared input data values, one per MAC cycle, to all MAC processors (i.e., all MAC processors operate on the same broadcast data value during a given multiply-and-accumulate (MAC) cycle.

Still referring to FIG. 1A, the various PHYs within inferencing IC 100 include a host I/O PHY 131 (e.g., compliant with a Peripheral Component Interconnect express (PCIe) standard or any other practicable standard or proprietary physical signaling hardware set/control protocol) to enable bidirectional information and/or instruction exchange with respect to a host processor or other control component; a memory-control PHY 133 to support read/write access to a system-level memory installation (e.g., dynamic random access memory (DRAM), flash memory, etc., disposed on a socketed memory module or implemented in any other practicable form factor), and one or more general-purpose I/O PHYs 135, 137 used, for example and without limitation, to coordinate operation between (gang) two or more inferencing ICs in a multi-chip inferencing system (with such multiple inferencing ICs 101 disposed in shared package to form a system-in-package, multi-package IC, three-dimensional IC, etc., or implemented as discrete components and interconnected via printed-circuit-board traces or other wired or wireless signaling media), establish network interconnect (e.g., according to any practicable Internet or intranet (WAN, LAN) physical layer interconnect and/or protocol suite), access nonvolatile storage media, etc. Various additional or alternative PHYs may be implemented within inferencing IC 101 in alternative embodiments, and any practicable higher-layer protocols may be implemented in connection with a given PHY (e.g., Compute Express Link or other memory-semantic protocol implemented over PCIe physical layer installation of host I/O PHY 131; memory control protocols according to various JEDEC standards implemented via memory control PHY 133; etc.). Also, the L3 and L2 memories disposed within (or accessed via) interconnect circuitry 103 may be implemented by various memory technologies in any combination (e.g., DRAM, static random access memory (SRAM), non-volatile memory, etc.) and, like processing-tile-resident L1 memory and TPU-resident L0 memory, are operationally distinguished by storage capacity and access speed/latency, with L0 memory nominally being the smallest, fasted on-chip memory and L3 being the largest (highest capacity), slowest on-chip memory. Additional or fewer memory levels may be implemented within the on-chip memory hierarchy in other embodiments, and the dispositions of individual memory levels may vary in all cases.

Referring again to the exemplary TPU detail view 105 (one of the sixteen TPUs disposed within processing tile 1 and coupled in common to the data output lines of the tile-resident L1 memory 109), each of the L multiply-accumulate units execute parallel tensor processing operations—in effect matrix multiplication operations in which a two dimensional matrix of FFT operands is vector-multiplied with an input-data tensor to produce an FFT result or partial FFT result. As discussed below, the input data tensor generally constitutes a fragment or sub-tensor of a substantially larger input tensor (i.e., with segments of that tensor progressively loaded into processing tiles 101 via hierarchical memory levels (and thus ultimately into L0 memories of individual TPUs 107) after retrieval from external memory and/or receipt from the host or data network via the memory PHY/host PHY/GPIO PHY) and the output tensor likewise constitutes a fragment or sub-tensor of a substantially larger output tensor (i.e., complete FFT result). The vector multiplication operation yields, as each component value within the output tensor, a convolution of the operand matrix and input tensor-multiplication of each weighting element within a given column of the operand matrix with a respective input data element within the input tensor to produce K multiplication products which are summed to produce a respective data element within the output tensor. Accordingly, in a vector multiplication of a operand matrix having K*L component values (FFT parameters) with an input data tensor having K data elements, each of L components of the output tensor is produced by performing K multiplication operations and K accumulations of the multiplication products into the tensor output value and thus K multiply-and-accumulate operations pipelined in a sequence of MAC cycles (i.e., generating multiplication product during a given MAC cycle and, during that same MAC cycle, adding product generated during previous MAC cycle into accumulated sum).

FIG. 1B illustrates an overview of a fast-fourier-transform-4K (FFT-4K) tensor processing unit (TPU) configuration implemented within the tiled TPU architecture (multiple TPUs per tile) of FIG. 1A. In the depicted example, three TPUs are coupled together to process four streams of input values. Each input stream consists of 16 complex values (two INT16 values) received per 32-cycle interval. Each of the 32 INT16 input values is broadcast to respective sets of multiply-accumulate (MAC) processors within the three TPUs and multiplied therein by the 16 complex values accessed in the 64 B filter weight word accessed within L0 memory. After 32 cycles, 16 complex products have been accumulated in the 64 accumulator registers. An unload cycle causes the 64 accumulator registers to be added and placed into the 32 serial-output registers.

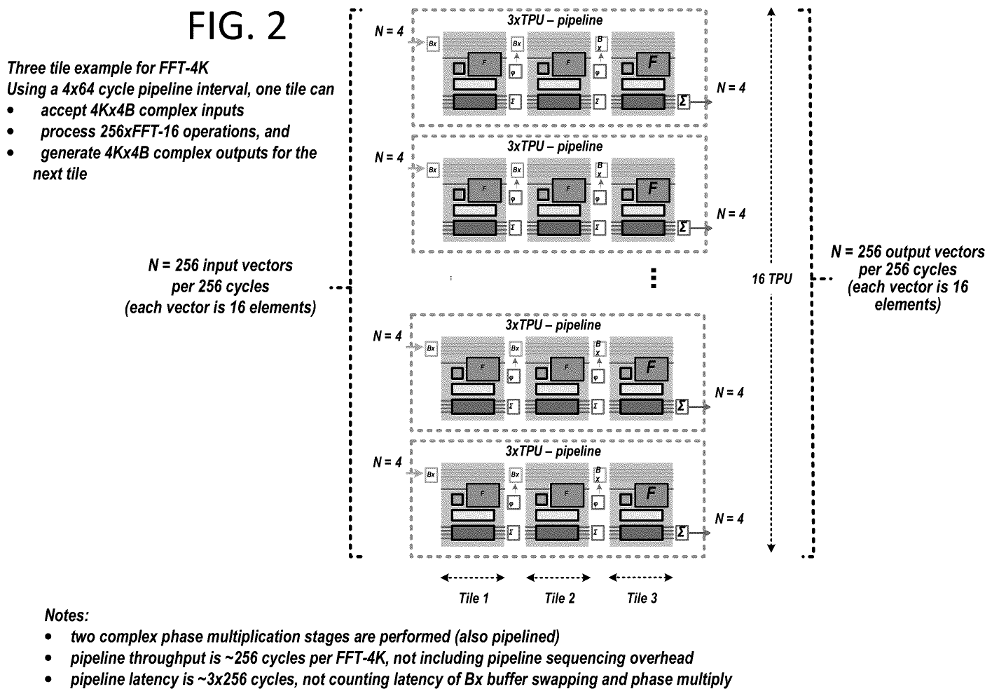

FIG. 2 illustrates an embodiment of a full, three-tile (48 TPU) implementation of the FFT-4K hardware. The 16 TPUs of the first tile accepts 64 streams of input values. Each input stream consists of 16 complex values (two INT16 values), received in a 32-cycle interval. Each of the 16 TPUs operated identically in parallel, handling 64×16 complex values (two INT16 values) in each 32 cycle interval. The 64×16 complex outputs (two INT32 values) in each 32 cycle interval are passed to the next set of 16 TPUs for the second stage. This is repeated once more for the third stage.

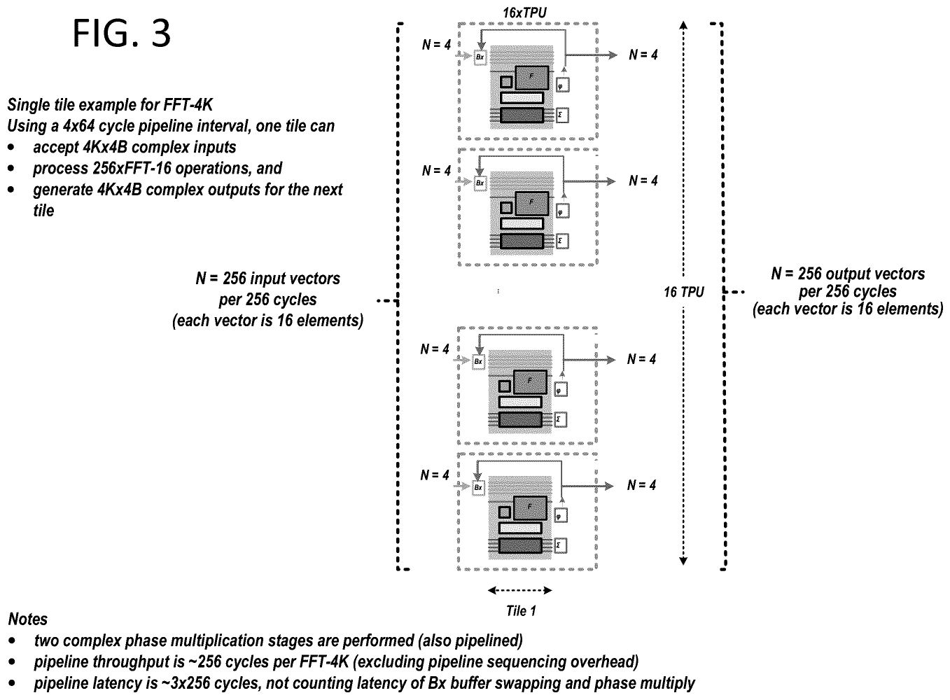

FIG. 3 illustrates an alternate implementation of the FFT-4K hardware that requires only one tile (16 TPUs in this example). As shown, the 16 TPUs of the tile accepts 64 streams of input values. As in FIG. 2, each input stream consists of 16 complex values (two INT16 values), received in a 32 cycle interval. Each of the 16 TPUs operates identically in parallel, handling 64×16 complex values (two INT16 values) in each 32 cycle interval. The 64×16 complex outputs (two INT32 values) in each 32 cycle interval are aggregated in a Bx buffer. After four 32-cycle intervals the 256×16 complex values are processed by the same set of 16 TPUs for the second stage (different phase shift values are used). This is repeated once more for the third stage processing.

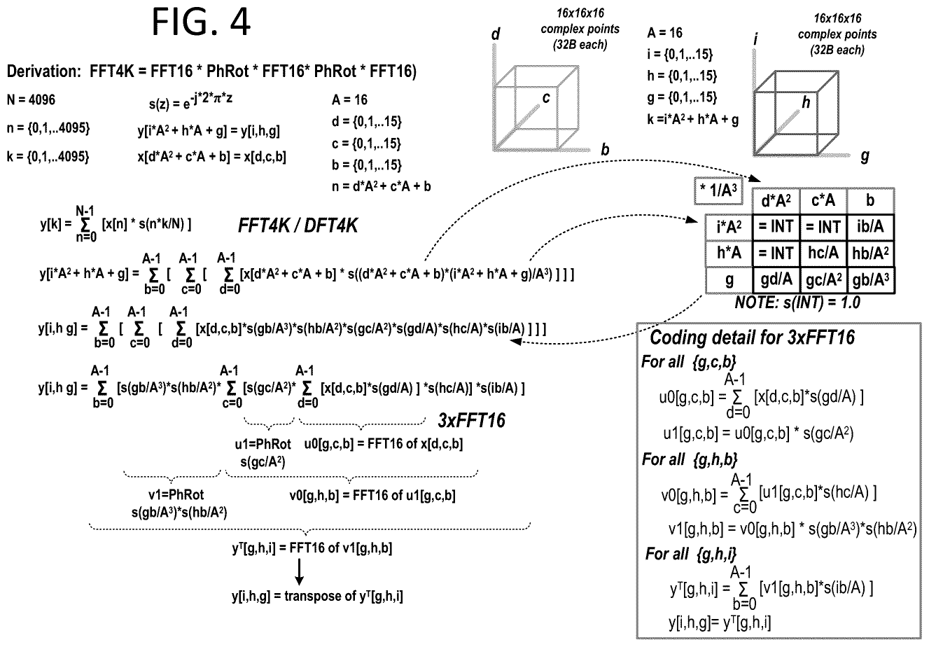

FIG. 4 shows an exemplary decomposition of an FFT-4K (actually DFT-4K) into three sets of FFT-16 (actually DFT-16). The DFT-4K definition is in the upper left of the figure (y[k]=Σx[n]*s(n*k/N)). This method requires O(N²) multiply-add operations for all the (n,k) values. Note that s(z)=e^{-j*2*πz}.

An FFT-4K (not specifically shown in FIG. 4) rearranges the depicted operations so that O(N*log(N)) multiply-add operations are required. The FIG. 4 approach rearranges these operations so that the TPU architecture is efficiently applied and only O(3*N*N^{1/3}) multiply-add operations are required.

The variables are summarized across the top of FIG. 4. The two index values (“n” and “k”) are converted into two linear expressions using three sub-indexes each, as follows:

$$\begin{matrix}n = d * {A}^{2} + c * A + b & A = 16 d , c , b =\end{matrix} \{ 0 , 1 , …15 \}$$

$$\begin{matrix}k = i * {A}^{2} + h * A + g & A = 16 i , h , g =\end{matrix} \{ 0 , 1 , …15 \}$$

These expressions are substituted into the DFT-4K expression ((y[k]=Σx[n]*s(n*k/N)) to become the expression (y[i*A2+h*A+g]= . . . ). Note that this new expression involves three nested summations, one for each of the three sub-indexes (b,c,d).

The expression for the phase-rotation (s(n*k/N)) has now become s((d*A²+c*A+b)*(i*A²+h*A+g)/A³). The nine terms are multiplied out in the table at the far right in FIG. 4. The entries marked “INT” will give a phase rotation value of +1.0—a rotation that is an integral multiple of 2*π and may be ignored.

There are six phase rotations remaining. Three of these are the phase-rotations needed for the three FFT-16 operations (s(gd/A), s(hc/A), s(ib/A)).

The other three phase rotations are applied between the FFT-16 operations. The (s(gc/A²)) term is applied after the first FFT-16, and the (s(gb/A³)*s(hb/A²)) terms are applied after the second FFT-16.

The grouping of the three summations is shown at the bottom of FIG. 4. The “d” summation is performed first, followed by the “c” summation, followed by the “b” summation. While the three summations may be performed concurrently to generate each particular y[i*A2+h*A+g] value, each summation may be performed, in fact, for all y[i*A2+h*A+g] values before the next summation is started—an approach that makes pipelined execution more efficient. The coding detail at the bottom right of FIG. 4 shows an exemplary order of execution.

As shown, the first summation of (x[d,c,b]*s(gd/A)) with the “d” index is performed across all {g,c,b} sub-indexes-requiring O(N^{4/3}) multiply-add operations (N=4096) and generating the u0[g,c,b] values. The u0[g,c,b] values are multiplied by s(gc/A²) to produce the u1[g,c,b] values (constituting the first phase rotation).

The second summation of (u1[g,c,b]*s(hc/A)) with the “c” index is performed across all {g,h,b} sub-indexes, requiring O(N^{4/3}) multiply-add operations (N=4096) and generating the v0[g,h,b] values. The v0[g,h,b] values are multiplied by s(gb/A³)*s(hb/A²) to give the v1[g,h,b] values (the second phase rotation).

The third summation of (v1[g,h,b]*s(ib/A)) with the “b” index is performed across all {g,h,i} sub-indexes-again requiring O(N^{4/3}) multiply-add operations (N=4096) and generating the y^{T}[g,h,i] values. The y[i,h,g] values are generated with a final transpose operation.

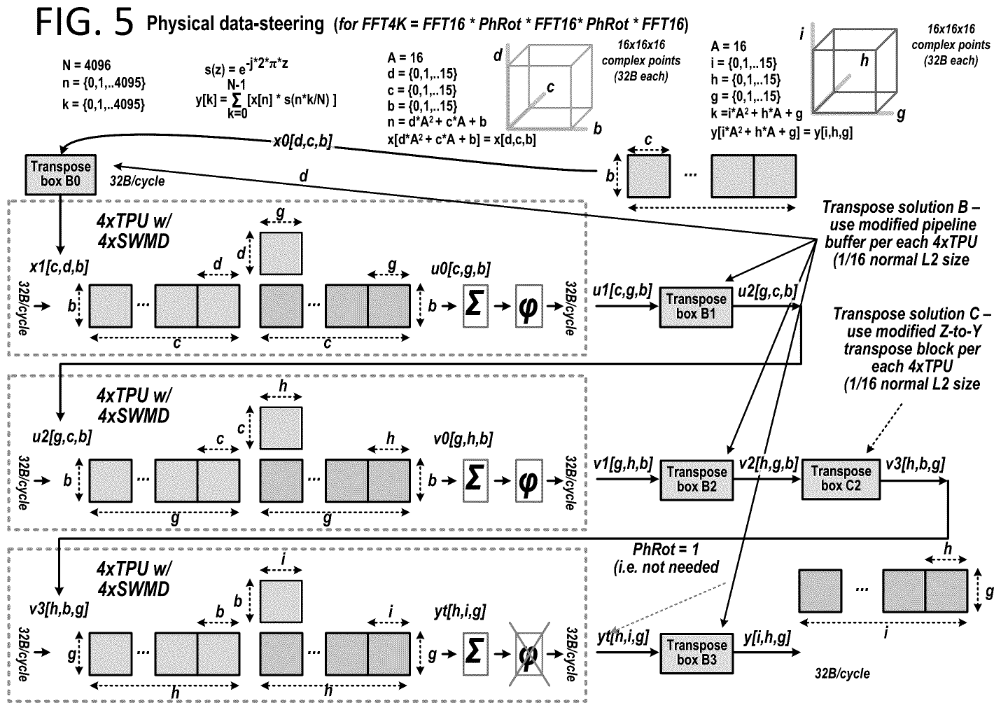

FIG. 5 illustrates exemplary physical data steering details for the three FFT-16 operations discussed in reference to FIG. 4. The terms and variables are summarized across the top of FIG. 5 (identical to those shown in FIG. 4), and operations shown beneath the term/variable summary (different from that shown in FIG. 4) presents an overview of how the various data structures are physically handled as they are processed within the TPU execution pipelines.

As shown, input samples x0[d,c,b] arrive in normal order; the least significant “b” sub-indexes vary most rapidly, and then the “c” sub-indexes, and then the “d′ indexes. The first operation applies a B0 transpose box (a buffer structure) to reverse the “c” and “d” ordering, yielding x1[c,d,b]—necessary in this particular example because the “d” sub-index participates in the first FFT-16 operation. In other words, x1[c,d,b] is processed as a series of “c” blocks, with each block with “b” rows, with row width “d”. These blocks are fed into the TPU execution pipeline. They are matrix-multiplied by the phase values held in an L0 block, with each block with “d” rows, with row width “g”.

The matrix-multiplication operations produce u0[c,g,b] as a series of “c” blocks, with each block with “b” rows, with row width “g”. The u0[c,g,b] output values are converted from INT32 values to INT16 values using conversion logic in the NLINX hardware block (i.e., logic circuitry that interconnects TPU inputs/outputs to those of other TPUs and/or other structures within the host IC). The u0[c,g,b] output values are also multiplied by the s(gc/A²) phase rotation values to give the u1[c,g,b] values. In the final operation, a B1 transpose box (a buffer structure) is applied to reverse the “c” and “g” ordering, producing u2[g,c,b].

Note that FIG. 5 illustrates an execution hardware set that includes four TPU pipelines, each with four SWMD channels (“single-weight, multiple-data” to accommodate the number of rows “b”). This is a simplification to enable a clear presentation of the data structure ordering. An actual implementation, in at least one embodiment, employs 16 TPU pipelines, each with four SWMD channels—allowing four “b” by “d” blocks to be processed in parallel and thereby reducing the time to process the “c” sub-index from 16 matrix multiplication intervals to four matrix multiplication intervals. In addition, this “b” by “d” parallel processing will simplify the C2 transpose block (described below).

Returning to the second FFT-16 step, the u2[g,c,b] blocks are fed into the second TPU execution pipeline. u2[g,c,b] is processed as a series of “g” blocks, with each block with “b” rows, with row width “c”. They are matrix-multiplied by the phase values held in an L0 block, with each block with “c” rows, with row width “h”. The matrix-multiplication operations produce v0[g,h,b] as a series of “g” blocks, with each block with “b” rows, with row width “h”. The v0[g,h,b] output values are converted from INT32 values to INT16 values using conversion circuitry/logic in the NLINX hardware block. The v0[g,h,b] output values are also multiplied by s(gb/A³)*s(hb/A²) phase rotation values to give the v1[g,h,b] values. Thereafter a B2 transpose box (a buffer structure) is applied to reverse the “h” and “g” index ordering, yielding v2[h,g,b] and then a C2 transpose box (a buffer structure) is applied to reverse the “b” and “g” index ordering, producing v3[h,b,g].

In the ensuing (second) FFT-16 step, the v3[h,b,g] blocks are fed into the third TPU execution pipeline. v3[h,b,g] is processed as a series of “h” blocks, with each block with “g” rows, with row width “b”. They are matrix-multiplied by the phase values held in an L0 (filter-weight memory) block, with each block with “b” rows, with row width “i”. The matrix-multiplication operations produce y^{T}[h,i,g] as a series of “h” blocks, with each block with “g” rows, with row width “i”. The y^{T}[h,i,g] output values are converted from INT32 values to INT16 values using conversion logic in the NLINX hardware block. Note that the y^{T}[h,i,g] output values are not multiplied by phase rotation. A B3 transpose box (a buffer structure) is applied in a final operation to reverse the “h” and “i” ordering, producing y[i,h,g].

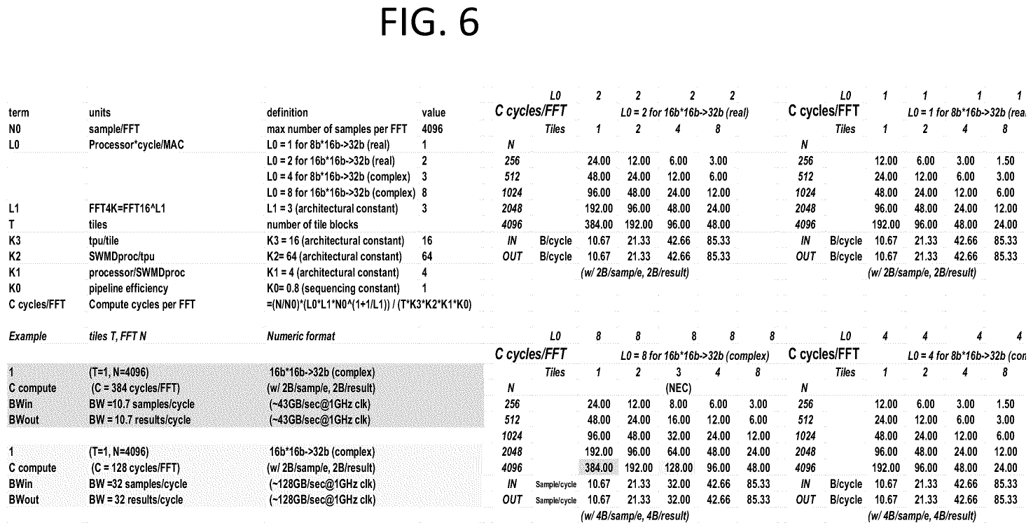

FIG. 6 presents an exemplary summary of the FFT execution interval as a function of the number of execution tiles (each tile contains 16 TPU pipelines). The FFT bandwidth will be equal to the inverse of this execution interval. Note that the execution interval is not the same as the execution latency (the execution latency is approximately constant at about 384 cycles).

The execution interval depends upon a number of parameters which are summarized on the left side of FIG. 6. Some of the parameters are fixed architectural constants: {K1, K2, K3, L1, NO}. Several others are variable. For example, the T parameter is the number of tiles (=1, 2, 3, 4, 8), the N parameter is the FFT size (=4K, 2K, 1K, 512, 256), the L0 parameter adjusts for one of four numeric precision options for the execution (=1, 2, 4, 8), and the K0 parameter adjusts for pipeline inefficiency (currently set to 1.0, but will probably end up at 0.8 with further analysis). The execution interval “C” is given by the expression:

C cycles/FFT=(N/N0)*(L0*L1*N0^{(1+1/L1)}/(T*K3*K2*K1*K0)

The FIG. 6 table contains two cases highlighted in dark and light shading—these are the 3-tile and 1-tile FFT-4K examples shown in earlier sections. Remember that the execution latency is approximately constant (3×128 cycles) for both cases. However, in the 3-tile case, the execution interval is ˜128 cycles since the three tiles are pipelined; i.e. a new FFT-4K data set is received every ˜128 cycles.

In the 1-tile case, the execution interval is ˜3×128 cycles since the single tile is reused three times; i.e. a new FFT-4K data set is received every ˜3×128 cycles. In the case of FFT-2K, the execution interval is reduced by 2× because there are two simultaneous FFT-2K taking place in the same time as one FFT-4 k. The same is true for FFT-{1K, 512, 256}, except the execution interval is reduced by {4×, 8×, 16×}. The input and output latency are approximately the same as execution latency (˜3×128 cycle), making the total operation latency approximately 9×128 cycle.

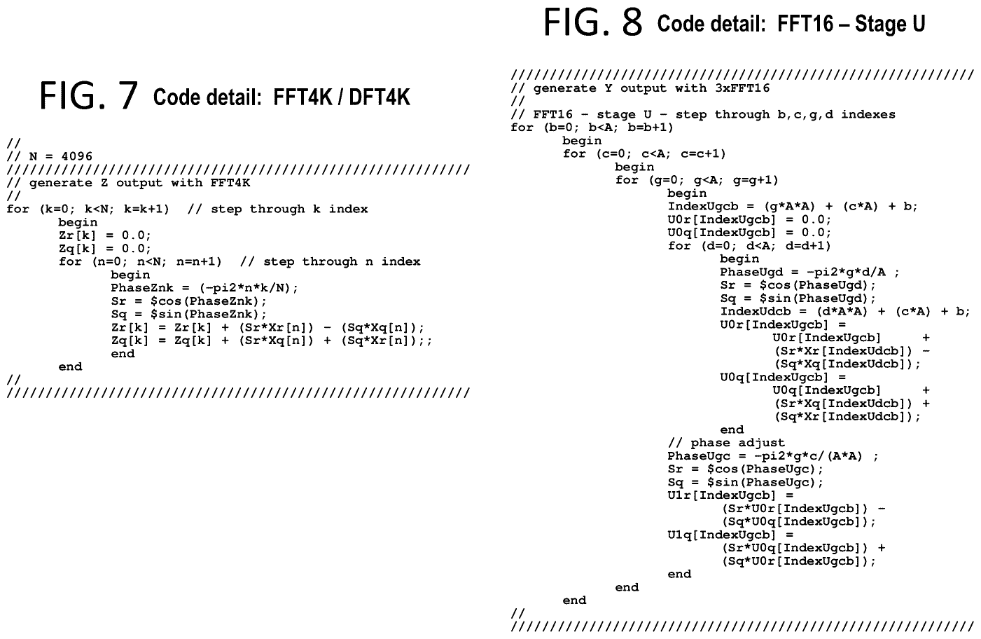

FIGS. 7-10 illustrate examples of procedural code that may be used to implement or model the FFT-4K approach described in reference to FIGS. 1A, 1B and 2-6.

FIG. 7 illustrates an exemplary implementation of a DFT-4K operation-a complex matrix multiply with 4096×4096 elements requiring 40,962 complex multiply-add operations. An FFT-4K (not specifically shown) performs a reordering so that only 12×4096 complex multiply-add operations are needed. A 3×FFT-16 (not specifically shown) performs a reordering so that only 48×4096 complex multiply-add operations are needed. The DFT-4K itself may be used for verification purposes.

Recalling that the DFT-4K may be defined as:

$$y [ k ] = \sum x [ n ] * s ( n * k / N ) , where N = 4096 ; k , n = \{ 0 , 1 , …4095 \} ; and s ( z ) = {e}^{- j * 2 * π * z}$$

The DFT-4K consists of two nested loops, each with 4096 iterations. The complex s(z) phase rotation value is calculated for each of the 16M cases, is complex multiplied by the X[n] input value, and accumulated in the Z[k] output value. Note that while the sequencing and data indexing is relatively straightforward for the DFT-4K, this is not the case for the FFT-4K implementation nor for the 3×FFT-16 implementation. The reduction in the number of complex multiply-add operations requires more complicated sequencing and data indexing-operations described in detail below for the 3×FFT-16 approach.

FIGS. 8-10 show exemplary code detail for the three FFT-16 stages applied in the 3×FFT-16 approach—an approach that may be deemed to implement 3×DFT-16 because a small radix DFT operation is leveraged to efficiently utilize the TPU execution unit.

FIG. 8 illustrates exemplary implementation of the first FFT-16 operation, referred to as “stage U.” As shown, stage U implements four nested loops, each with 16 iterations-requiring 164 operational steps (as compared to the 40962 operational steps of the DFT-4K described in the previous section) and thus reducing the number of complex multiply-add operations by a factor of 256. This savings is present in all three FFT-16 stages.

Still referring to FIG. 8, the loop indexes are the sub-indices {b, c, g, d} for the input array X[d,c,b] and the output array U0[g,c,b] (note that the sub-index notation “[a,b,c]” means “a*A*A+b*A+c”, where A=16) and, as the procedure performs a single access at a time, it uses sub-index arithmetic to locate the proper element. The parallel hardware of the 16 TPUs requires 64 elements (of the 4096 total) to be accessible in a single cycle—an accommodation implemented by the transpose buffers described below. The three outer-most loops of Stage U use the {b,c,g} sub-indices to create a pointer IndexUgcb, and also to zero out the output element U0[IndexUgcb]. The inner-most loop uses the {g,d} sub-indices to create the phase-angle “−pi2*g*d/A”, and to generate the COS and SIN values for a complex multiplication (i.e. the real/imaginary components of e^{-j*2*π*g*d/A}). The inner-most loop also uses the {d,c,b} sub-indices to create a pointer IndexUdcb, used in turn to access each of the input elements X[IndexUdcb]. The input value X[IndexUdcb] is multiplied by e^{-j*2*π*g*d/A} and accumulated in U0[IndexUgcb]. After the inner loop completes, the {g,c} sub-indices are used to create the phase-angle “−pi2*g*c/A” and to generate the COS and SIN values for a complex multiplication (i.e. the real/imaginary components of e^{-j*2*π*g*c/A}). The accumulation output total U0[IndexUgcb] is multiplied by e^{-j*2*π*g*c/A} to produce the final output U1[IndexUgcb]—the data input for the next FFT-16 (stage V).

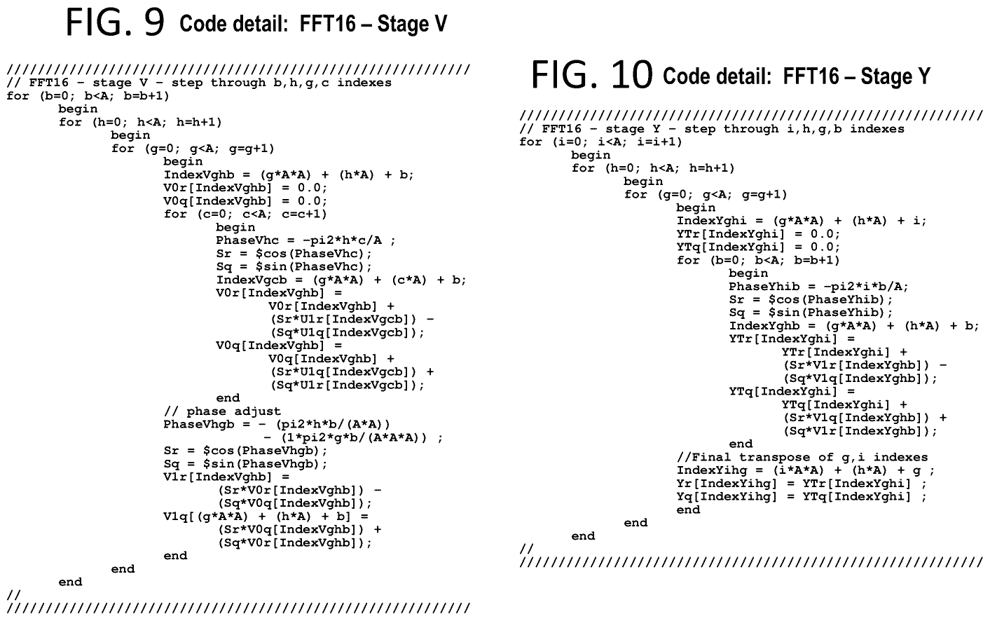

FIG. 9 shows the implementation of the second FFT-16 operation, “stage V.” As in prior stage U, stage V employs four nested loops, each with 16 iterations, reducing the required number of operational steps from 40,962 to 164 (as compared to the DFT-4K described above) and thereby reducing the number of complex multiply-add operations by 256×.

In the depicted example, the loop indexes are the sub-indices {b, h, g, c} for both the input array U1[g,c,b] and the output array V0[g,h,b] (note that the sub-index notation “[a,b, c]” means “a*A*A+b*A+c”, where A=16) and, as the processing performs one access at a time, the approach uses sub-index arithmetic to locate the proper element to be accessed. The parallel hardware of the 16 TPUs requires 64 elements (of the 4096 total) to be accessible in a single cycle—an arrangement effected by the transpose buffers discussed below. The three outer-most loops of Stage V use the {b,h,g} sub-indices to create a pointer Index Vghb, and also to zero out the output element V0[Index Vghb]. The inner-most loop uses the {h,c} sub-indices to create the phase-angle “−pi2*h*c/A”, and to generate the COS and SIN values for a complex multiplication (i.e. the real/imaginary components of e^{-j*2*π*h*c/A}). The inner-most loop also uses the {d,c,b} sub-indices to create a pointer Index Vgcb. This pointer accesses each of the input elements U1[Index Vgcb]. The input value U1[Index Vgcb] is multiplied by e^{-j*2*π*h*c/A} and accumulated in V0[Index Vghb]. After the inner loop completes, the {h,b,g} sub-indices are used to create the phase-angles “−pi2*h*b/A²” and “−pi2*g*b/A³” and to generate the COS and SIN values for a complex multiplication (i.e. the real/imaginary components of e^{-j*2*π*h*b/AA}*e^{-j*2*π*g*b/AAA}). The accumulation output total, V0[Index Vghb], is multiplied by e^{-j*2*π*h*b/AA}*e^{-j*2*π*g*b/AAA} to produce the final output, V1[Index Vghb]—the data input for the next FFT-16, “stage Y.”

FIG. 10 shows exemplary implementation of the third FFT-16 stage (stage Y). As in prior stages U and V, stage Y employs four nested loops, each with 16 iterations—reducing the required number of operational steps from 40,962 to 164 (as compared to the DFT-4K described above) and thereby reducing the number of complex multiply-add operations by a factor of 256.

In the depicted example, the loop indexes are the sub-indices {i, h, g, b} for the input array V1[g,h,b] and the output array Y^{T}[g,h,i] (again, the sub-index notation “[a,b,c]” refers to “a*A*A+b*A+c”, where A=16) and, as one access is executed at a time, the stage Y approach uses sub-index arithmetic to locate the proper element to be accessed Also, as in stages U and V, transpose buffer(s) ensure that 64 of the total 4096 elements are accessible per cycle by the parallel hardware of the 16 TPUs requires 64.

The three outer-most loops of Stage Y use the {i,h,g} sub-indices to create a pointer Index Yghi, and also to zero out the output element Y^{T}[Index Yghi]. The inner-most loop uses the {b,i} sub-indices to create the phase-angle “−pi2*b*i/A”, and to generate the COS and SIN values for a complex multiplication (i.e. the real/imaginary components of e^{-j*2*π*b*i/A}). The inner-most loop also uses the {d,c,b} sub-indices to create a pointer Index Yghb used, in turn, to access each of the input elements V1[Index Yghb]. The input value V1[Index Yghb] is multiplied by e^{-j*2*π*b*i/A} and accumulated in Y^{T}[Index Yghi]. The accumulation output total Y^{T}[Index Yghi] is transposed to Y[Index Yihg]—the final result for the 3×FFT16 (i.e., 3-stage U, V, Y) operation.

In a number of embodiments, the 3×FFT16 hardware can be reconfigured to handle various sample sizes, including for example and without limitation sample sizes in the range FFT-{4K, 2K, 1K, 512, 256}-configurations discussed below.

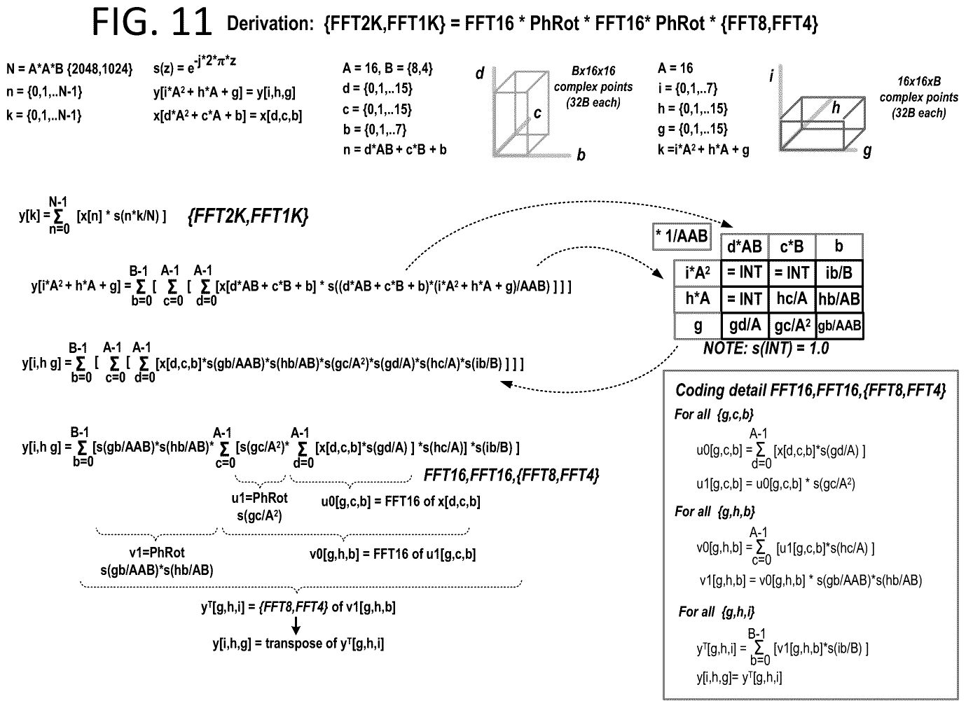

FIG. 11 illustrates exemplary decomposition of an FFT-2K (actually DFT-2K) into two sets of FFT-16 (actually DFT-16) and one set of FFT-8. It also shows the decomposition of an FFT-1K into two sets of FFT-16 and one set of FFT-4—decomposition that may be extended for FFT-512 and FFT-256 (at least) with a final FFT2 and FFT1, respectively.

No performance is lost when the lower radix is adjusted as the architectural symmetry enables parallel implementation of decomposed FFTs. For example, two FFT-2K operations may be carried out using the same hardware set applied for a single FFT-4K operation. Similarly, 4×FFT-1K, 8×FFT-512, and 16×FFT-256 operations can be performed instead of one FFT-4K. FIG. 11 illustrates detail with respect to these operations-similar to FIG. 4 (FFT-4K derivation) discussed above, but with important differences, including that N=A*A*B instead of N=A*A*A. In the FIG. 11 example, A=16 and B={8, 4, 2, 1}.

As in FIG. 4, the variables are summarized across the top of FIG. 11. The two index values (“n” and “k”) are converted into two linear expressions using three sub-indexes each—note that the “B” variable has replaced the “A” at several points in the expressions (i.e., as compared with the FIG. 4 derivation), and the range of {b,i} are reduced as follows:

$$n = d * a * B + c * B + b A = 16 d , c = \{ 0 , 1 , …15 \}$$

$$B = \{ 8 , 4 , 2 , 1 \} b = \{ 0 , 1 , … B - 1 \}$$

$$k = i * {A}^{2} + h * A + g A = 16 h , g = \{ 0 , 1 , …15 \}$$

$$B = \{ 8 , 4 , 2 , 1 \} i = \{ 0 , 1 , … B - 1 \}$$

The foregoing expressions are substituted into the DFT-4K expression ((y[k]=Σx[n]*s(n*k/N)) to become the expression (y[i*A2+h*A+g]= . . . ). Note that this new expression involves three nested summations, one for each of the three sub-indexes (b,c,d). Also note that the “b” summation has “B” accumulations.

The expression for the phase-rotation (s(n*k/N)) has now become s((d*A*B+c*B+b)*(i*A²+h*A+g)/A³). The nine terms are multiplied out in the table at the far right. The entries marked “INT” will give a phase rotation value of +1.0 (a rotation that is an integral multiple of (2*π) that may be ignored.

There are six phase rotations remaining. Three of these are the phase-rotations needed for the three FFT-16 operations (s(gd/A), s(hc/A), s(ib/B)). The other three phase rotations are applied in-between the FFT-16 operations. The (s(gc/A²)) term is applied after the first FFT-16, and the (s(gb/A²*B)*s(hb/A*B)) terms are applied after the second FFT-16. The grouping of the three summations is shown at the bottom of FIG. 11. The “d” summation is performed first, followed by the “c” summation, followed by the “b” summation. This description implies that the three summations are performed to generate each particular y[i*A2+h*A+g] value. In actual implementation, each summation is performed for all y[i*A2+h*A+g] values before the next summation is started—an approach that makes the pipelined execution more efficient. The coding detail at the bottom right of FIG. 11 shows this execution order.

The first summation of (x[d,c,b]*s(gd/A)) with the “d” index is performed across all {g,c,b} sub-indexes-requiring O(A³*B) multiply-add operations (where A³=N=4096) and generates the u0[g,c,b] values multiplied by s(gc/A²) to produce the u1[g,c,b] values (the first phase rotation).

The second summation of (u1[g,c,b]*s(hc/A)) with the “c” index is performed across all {g,h,b} sub-indexes, again requiring O(A³*B) multiply-add operations and generating the v0[g,h,b] values that are multiplied by s(gb/A³)*s(hb/A²) to give the v1[g,h,b] values (the second phase rotation.

The third summation of (v1[g,h,b]*s(ib/A)) with the “b” index is performed across all {g,h,i} sub-indexes (note that the “b” summation has “B” accumulations), requiring O(A³*B) multiply-add operations and producing the y^{T}[g,h,i] values. The y[i,h,g] values are generated with a final transpose operation.

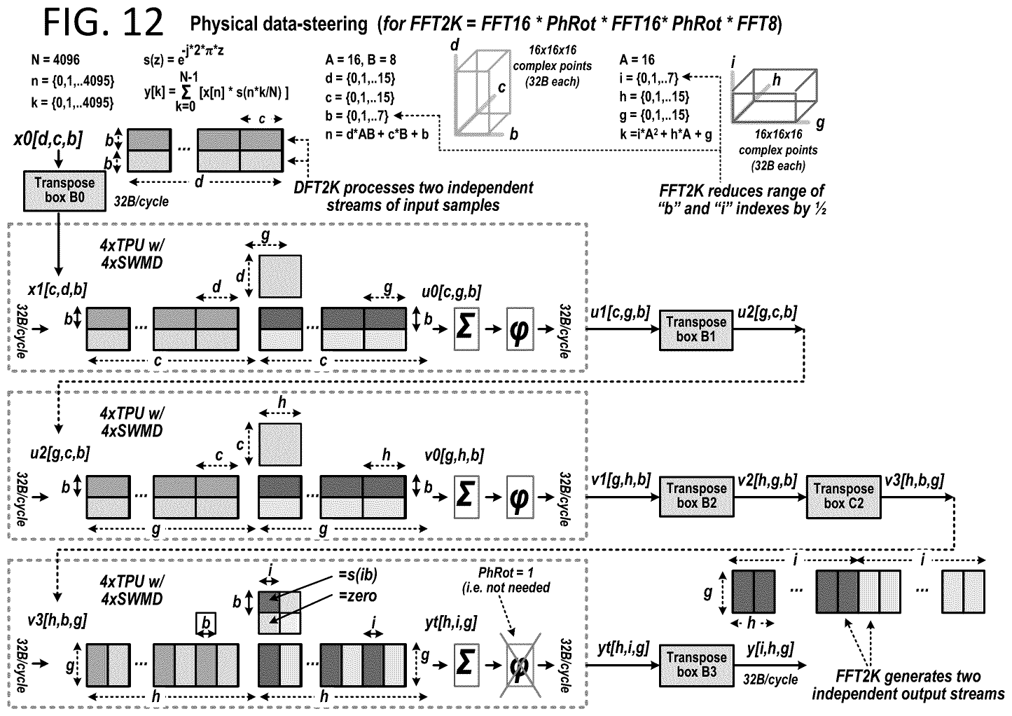

FIG. 12 illustrates exemplary data steering details for the FFT-2K sub-operations described above. The terms and variables are summarized across the top of the figure (identical to those shown in FIG. 11) while the material below presents an overview of how the various data structures are physically handled as they are processed by the TPU execution pipelines.

In the depicted example, the input samples x0[d,c,b] arrive in normal order: the least significant “b” sub-indexes vary most rapidly, and then the “c” sub-indexes, and then the “d′ indexes. In an initial operation, a B0 transpose box (a buffer structure) is applied to reverse the “c” and “d” ordering (yielding x1[c,d,b]) and arrangement that facilitates participation of the “d” sub-index in the first FFT-16 operation. By this arrangement, x1[c,d,b] is processed as a series of “c” blocks (each block with “b” rows of row-width “d”) that are fed into the TPU execution pipeline and matrix-multiplied by the phase values held in an L0 block (i.e., having “d” rows, with row width “g”). Note for the FFT-2K example, two separate data blocks (different shades of orange/purple), each with “b” rows, are processed simultaneously. The matrix-multiplication operations produce u0[c,g,b] as a series of “c” blocks, with each block with “b” rows, with row width “g”. Again, note that two separate data blocks are processed simultaneously.

The u0[c,g,b] output values are converted from INT32 values to INT16 values using conversion logic in the NLINX hardware block. The u0[c,g,b] output values are also multiplied by the s(gc/A²) phase rotation values to give the u1[c,g,b] values. In a final operation, a B1 transpose box (a buffer structure) is applied to reverse the “c” and “g” ordering, providing u2[g,c,b].

Still referring to FIG. 12, the depicted example shows four TPU pipelines within the execution hardware, each TPU pipeline having four SWMD channels (to accommodate the number of rows “b”). This is a simplification to explicate the data structure ordering as an actual implementation employs 16 TPU pipelines, each with four SWMD channels—an arrangement that allows four “b” by “d” blocks to be processed in parallel, thereby reducing the time to process the “c” sub-index from 16 matrix multiplication intervals to four matrix multiplication intervals and also simplifying operation of the C2 transpose block (discussed below).

Returning to the second FFT-16 operation, the u2[g,c,b] blocks are fed into the second TPU execution pipeline. Each u2[g,c,b] block is processed as a series of “g” blocks, with each “g” block having “b” rows of row-width “c”. The “g” blocks are matrix-multiplied by the phase values held in an L0 block, each L0 block having “c” rows of row-width “h” (note again that two separate data blocks are processed simultaneously). The matrix-multiplication operations produce v0[g,h,b] as a series of “g” blocks, with each block with “b” rows, with row width “h”.

Continuing with FIG. 12, the v0[g,h,b] output values are converted from INT32 values to INT16 values using conversion logic in the NLINX hardware block. The v0[g,h,b] output values are also multiplied by s(gb/A²*B)*s(hb/A*B) phase rotation values to produce the v1[g,h,b] values. Thereafter, a B2 transpose box (a buffer structure) is applied to reverse the “h” and “g” ordering, yielding v2[h,g,b], and then a C2 transpose box (a buffer structure) is applied to reverse the “b” and “g” ordering, producing v3[h,b,g].

In the third FFT-16 step, the v3[h,b,g] blocks are fed into the third TPU execution pipeline, enabling v3[h,b,g] to be processed as a series of “h” blocks, with each block with “g” rows of row-width “b”. The “h” blocks are matrix-multiplied by the phase values held in an L0 block, with each L0 block having “b” rows of row-width “i”. Two separate data blocks are processed sequentially: the “b” columns of the first data block followed by the “b” columns of the second data block. The phase rotation values in L0 are divided into four quarters, with the s(ib) values in two quarters and zero values in the other two quarters. The matrix-multiplication operations produce yt[h,i,g] as a series of “h” blocks each having “g” rows of row-width “i”. The two different 2K data sequences are interleaved.

The yt[h,i,g] output values are converted from INT32 values to INT16 values using conversion logic in the NLINX hardware block (note that the yt[h,i,g] output values are not multiplied by phase rotation) and then a B3 transpose box (a buffer structure) is applied to reverse the “h” and “i” ordering, producing y[i,h,g]. The two different 2K data sequences are no longer interleaved and instead streamed as two sequential blocks (other transpose options can readily be configured as different applications may require).

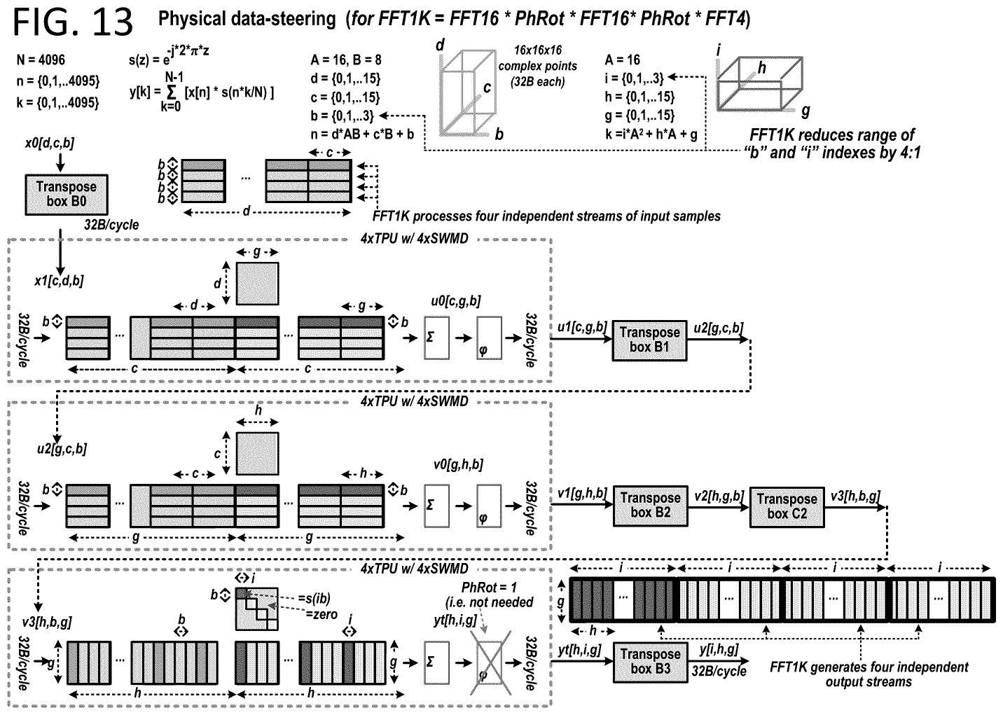

FIG. 13 illustrates exemplary data steering details for the FFT-1K operations described previously. The terms and variables—summarized across the top of FIG. 13—are identical to those shown in FIG. 12, while the ensuing material (different from FIG. 12) overviews physical handling of the various data structures as they are processed by the TPU execution pipelines.

The input samples x0[d,c,b] arrive in normal order: the least significant “b” sub-indexes vary most rapidly, and then the “c” sub-indexes, and then the “d′ indexes. In an initial operation, a B0 transpose box (a buffer structure) is applied to reverse the “c” and “d” ordering, yielding x1[c,d,b], and thereby enabling participation of the “d” sub-index in the first FFT-16 operation. Thus, x1[c,d,b] is processed as a series of “c” blocks each having “b” rows of row-width “d”. When fed into the TPU execution pipeline, the “c” blocks are matrix-multiplied by the phase values held in an L0 block (each L0 block having “d” rows of width “g”), with four separate data blocks (differently shaded in FIG. 13 and each having “b” rows) being processed simultaneously.

The matrix-multiplication operations produce u0[c,g,b] as a series of “c” blocks each having “b” rows of row-width “g” (again, four separate data blocks are processed simultaneously). The u0[c,g,b] output values are converted from INT32 values to INT16 values using conversion logic in the NLINX hardware block. The u0[c,g,b] output values are also multiplied by the s(gc/A²) phase rotation values to produce the u1[c,g,b] values. Thereafter, a B1 transpose box (a buffer structure) is applied to reverse the “c” and “g” ordering, producing u2[g,c,b].

While four TPU pipelines (each with four SWMD channels to accommodate the number of rows “b”) are depicted within the FIG. 13 execution hardware, an actual implementation may employ 16 TPU pipelines, each with four SWMD channels to enable four “b” by “d” blocks to be processed in parallel (thereby reducing the time to process the “c” sub-index from 16 matrix multiplication intervals to four matrix multiplication intervals) and simplifying C2 transpose block implementation (as discussed below).

Returning to the second FFT-16 step, the u2[g,c,b] blocks are fed into the second TPU execution pipeline and processed therein as a series of “g” blocks each having “b” rows of row-width “c”. The “g” blocks are matrix-multiplied by the phase values held in an L0 block (each L0 block having “c” rows of row-width “h”) with four separate data blocks being processed simultaneously.

The matrix-multiplication operations produce v0[g,h,b] as a series of “g” blocks each having “b” rows of row-width “h”. The v0[g,h,b] output values are converted from INT32 values to INT16 values using conversion logic in the NLINX hardware block and multiplied by s(gb/A²*B)*s(hb/A*B) phase rotation values to produce the v1[g,h,b] values. A B2 transpose box (a buffer structure) is then applied to reverse the “h” and “g” ordering (yielding v2[h,g,b]) and then a C2 transpose box (a buffer structure) is applied to reverse the “b” and “g” ordering, producing v3[h,b,g].

In the third FFT-16 step, the v3[h,b,g] blocks are fed into the third TPU execution pipeline and processed therein as a series of “h” blocks each having “g” rows of row-width “b”. The “h” blocks are matrix-multiplied by the phase values held in an L0 block (each L0 block having “b” rows of row-width “i”) with four separate data blocks processed sequentially—the “b” columns of the first data block followed by the “b” columns of the second data block, and so forth. In the depicted example, phase rotation values in L0 are divided into 16 sections, with the s(ib) values in four sections and zero values in the other 12 sections.

The matrix-multiplication operations produce yt[h,i,g] as a series of “h” blocks each having “g” rows of row-width “i”, interleaving the two 2K data sequences. The yt[h,i,g] output values are converted from INT32 values to INT16 values using conversion logic in the NLINX hardware block (note that the yt[h,i,g] output values are not multiplied by phase rotation) and then a B3 transpose box (a buffer structure) is applied to reverse the “h” and “i” ordering, producing y[i,h,g]. The four different 1K data sequences are no longer interleaved but instead streamed as four sequential blocks (other transpose options can readily be configured as a given application may require).

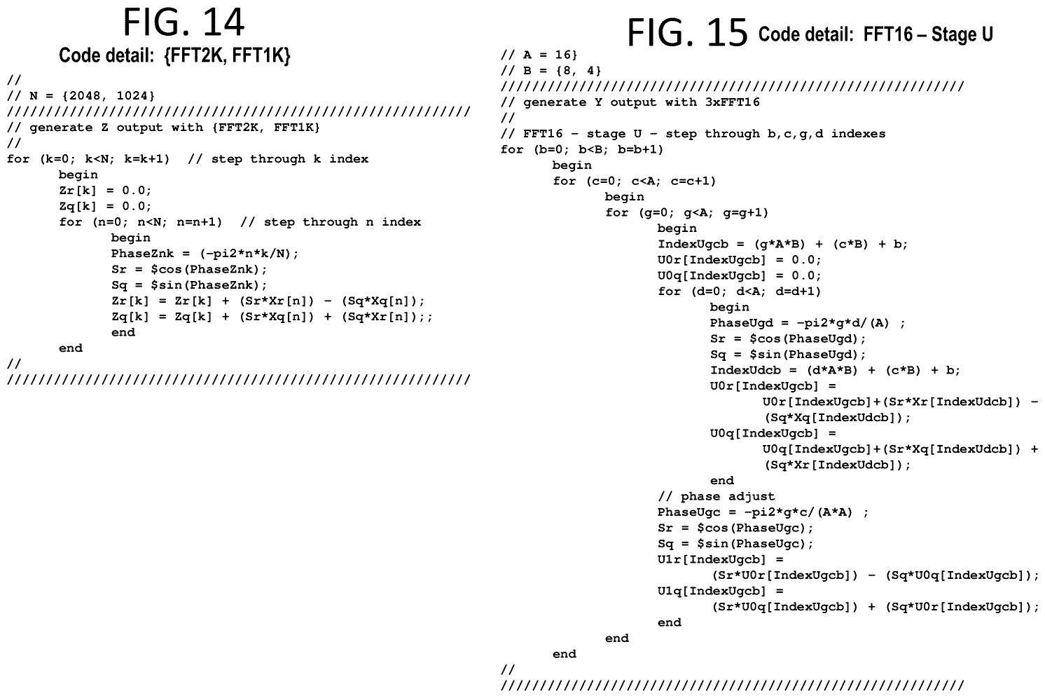

FIGS. 14-17 illustrate exemplary procedural code implementations/modeling of the FFT-{2K, 1K, 512, 256} approach described above.

FIG. 14 illustrates an exemplary implementation of a DFT-{2K, 1K, 512, 256} operation—(i.e., “DFT-N”) a complex matrix multiply with N×N elements requiring N² complex multiply-add operations. A modified FFT-4096 (not specifically shown) performs a reordering so that only 12×4096×(N/4096) complex multiply-add operations are needed. A modified 3×FFT-16 (not specifically shown) performs a reordering so that only 48×4096×(N/4096) complex multiply-add operations are needed. The DFT-N may be used for verification purposes (e.g., confirming hardware operation).

Still referring to FIG. 14, the DFT-N may be expressed as follows:

y[k]=>x[n]*s(n*k/N), where N={2K,1K,512,256}; k,n={0,1, . . . N−1}; s(z)=e^{-j*2*π*z}

Accordingly, in one embodiment, the DFT-N is implemented by two nested loops, each with N iterations. The complex s(z) phase rotation value is calculated for each of the 16M cases and complex-multiplied by the X[n] input value, with the multiplication result accumulated in the Z[k] output value. While sequencing and data indexing is relatively straightforward for the DFT-N, sequencing and data-indexing are substantially more complex for the FFT-4K and 3×FFT-16 implementations as the reduction in the number of complex multiply-add operations requires more complicated sequencing and data indexing-operations described below for the 3×FFT-16 approach.

FIGS. 15-17 illustrate exemplary code detail for the three FFT-16 stages applied to implement the 3×FFT-16 (which may be deemed a “3×DFT-16” approach as a small radix DFT operation is leveraged to enable efficient application the TPU execution unit).

FIG. 15 shows the implementation of the initial FFT-16 operation, referred to herein as stage U. As shown, the stage U FFT is implemented in four nested loops-three with 16 iterations and one with progressively fewer {8, 4, 2, 1} iterations—and requires A³*B operations. The loop indexes are the sub-indices {b, c, g, d} for the input array X[d,c,b] and the output array U0[g,c,b] (in stage U, the sub-index notation “[a,b,c]” means “a*A*B+b*B+c”, where A=16, B={8, 4, 2, 1}) and sub-index arithmetic is used to locate the proper element as only one access is executed at a time.

To leverage the parallel hardware of the 16 TPUs, 64 processing elements (of the 4096 total) are made accessible in each single cycle by the transpose buffers (described below). The three outer-most loops of Stage U use the {b,c,g} sub-indices to create a pointer IndexUgcb and also to zero out the output element U0[IndexUgcb]. The inner-most loop uses the {g,d} sub-indices to create the phase-angle “−pi2*g*d/A” and to generate the COS and SIN values for a complex multiplication (i.e. the real/imaginary components of e^{-j*2*π*g*d/A}). The inner-most loop also uses the {d,c,b} sub-indices to create a pointer IndexUdcb. This pointer accesses each of the input elements X[IndexUdcb]. The input value X[IndexUdcb] is multiplied by e^{-j*2*π*g*d/A} and accumulated in U0[IndexUgcb].

After the inner loop completes, the {g,c} sub-indices are used to create the phase-angle “−pi2*g*c/A²” and to generate the COS and SIN values for a complex multiplication (i.e. the real/imaginary components of e−j*2*πg*c/A*A). The accumulation output total U0[IndexUgcb] is multiplied by e^{-j*2*π*g*c/A*A} to give the final output U1[IndexUgcb], the data input for the next FFT-16 (stage V).

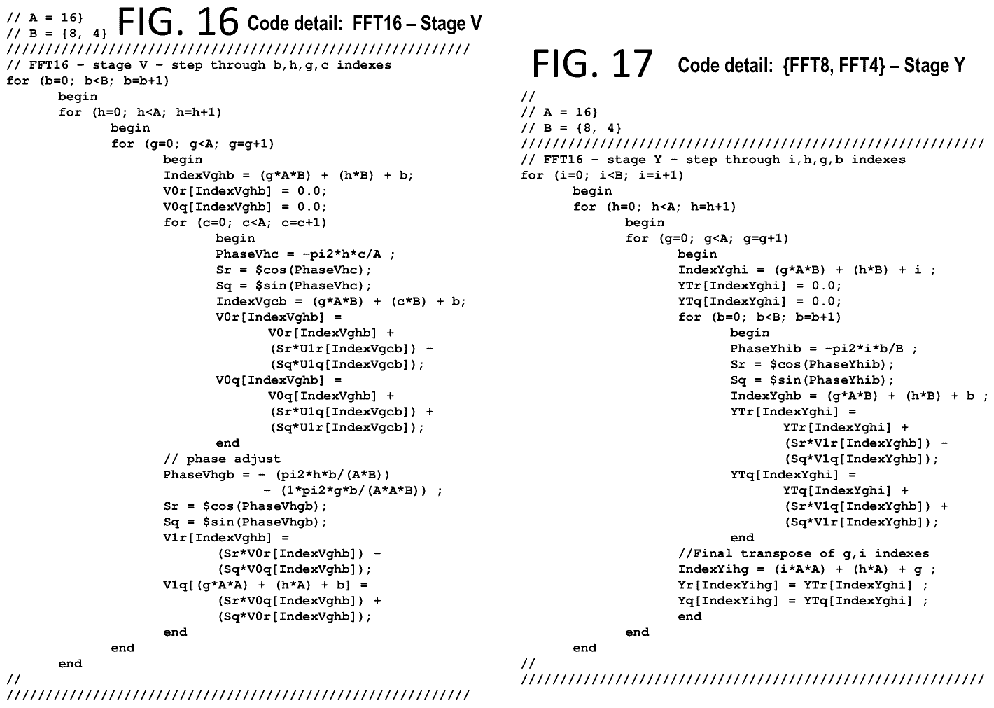

FIG. 16 illustrates exemplary implementation of the second of the three FFT-16 stages, stage V—also implemented in four nested loops (three with 16 iterations and one with progressively fewer {8, 4, 2, 1} iterations) that implement A³*B operations.

The loop indexes are the sub-indices {b, h, g, c} for the input array U1[g,c,b] and the output array V0[g,h,b] (as in stage U, the sub-index notation “[a,b,c]” means “a*A*B+b*B+c”, where A=16, B={8, 4, 2, 1}) and sub-index arithmetic is used to locate the proper element, as only one access is performed at a time. As in stage U, the parallel hardware of the 16 TPUs is leveraged by making 64 processing elements (of the 4096 total) accessible in single cycle—effected by the transpose buffers as described below.

The three outer-most loops of Stage V use the {b,h,g} sub-indices to create a pointer Index Vghb and also to zero out the output element V0[IndexVghb]. The inner-most loop uses the {h,c} sub-indices to create the phase-angle “−pi2*h*c/A” and to generate the COS and SIN values for a complex multiplication (i.e. the real/imaginary components of e^{-j*2*π*h*c/A}). The inner-most loop also uses the {d,c,b} sub-indices to create a pointer Index Vgcb—a pointer used to access each of the input elements U1[Index Vgcb]. The input value U1[Index Vgcb] is multiplied by e^{-j*2*π*h*c/A} and accumulated in V0[Index Vghb].

After the inner loop completes, the {h,b,g} sub-indices are used to create the phase-angles “−pi2*h*b/A*B” and “−pi2*g*b/A*A*B” and to generate the COS and SIN values for a complex multiplication (i.e. the real/imaginary components of e^{-j*2*π*h*b/AB}*e^{-j*2*T*g*b/AAB}) The accumulation output total V0[Index Vghb] is multiplied by e^{-j*2*π*h*b/AB}*e^{-j*2*π*g*b/AAB} to produce the final output V1[Index Vghb], the data input for the third-stage FFT-16, stage Y.

FIG. 17 illustrates an embodiment of the third FFT-16 stage (stage Y) that, like stages U and V, includes four nested loops (three with 16 iterations and one with progressively fewer {8, 4, 2, 1} iterations) that implement A³*B operations.

The loop indexes are the sub-indices {i, h, g, b} for the input array V1[g,h,b] and the output array Y^{T}[g,h,i] (as in stages U and V, the sub-index notation “[a,b,c]” means “a*A*B+b*B+c”, where A=16, B={8, 4, 2, 1}) and sub-index arithmetic is used to locate the proper element, as only one access is performed at a time. As in stages U and V, the parallel hardware of the 16 TPUs is leveraged by making 64 processing elements (of the 4096 total) accessible in single cycle-effected by the transpose buffers as described below.

The three outer-most loops of Stage Y use the {i,h,g} sub-indices to create a pointer Index Yghi and also to zero out the output element YT[IndexYghi]. The inner-most loop uses the {b,i} sub-indices to create the phase-angle “−pi2*b*i/B”, and to generate the COS and SIN values for a complex multiplication (i.e. the real/imaginary components of e^{-j*2*π*b*i/B}). The inner-most loop also uses the {g,h,b} sub-indices to create a pointer Index Yghb—a pointer used to access each of the input elements V1[Index Yghb], with each input value V1[Index Yghb] being multiplied by e^{-j*2*π*b*i/B} and the multiplication result accumulated in YT[Index Yghi]. The accumulation output total YT[Index Yghi] is transposed to yield the final result for the 3×FFT16 operation, Y[Index Yihg].

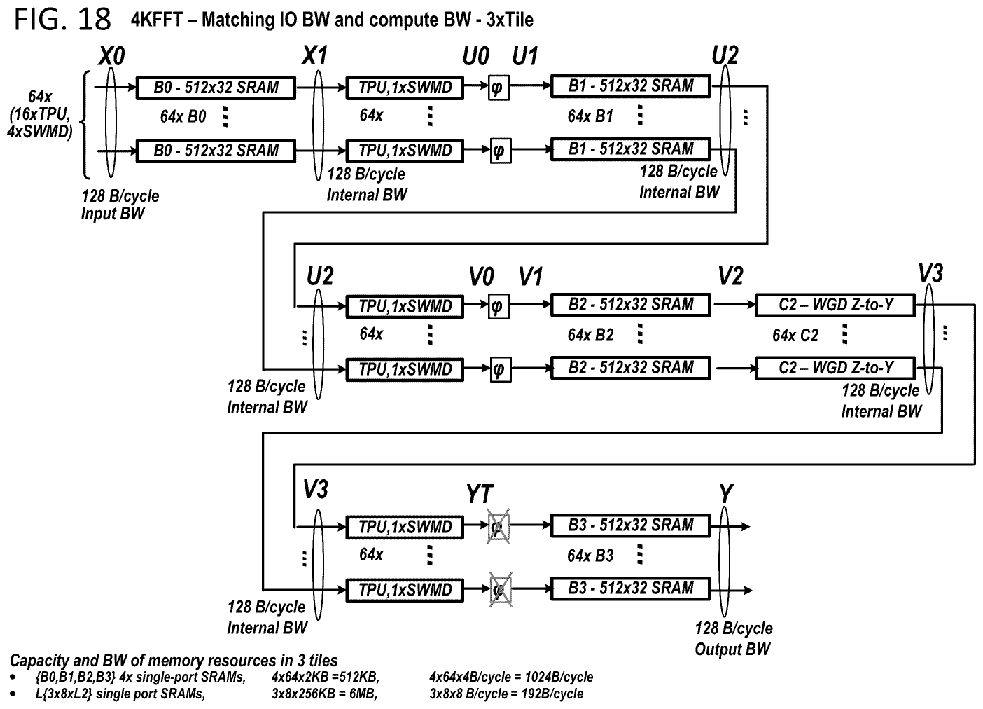

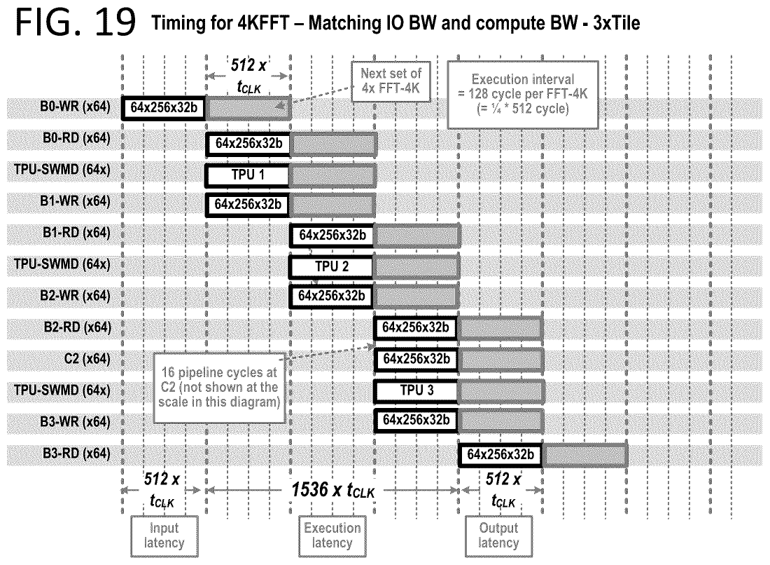

FIGS. 18-21 present transport details for FFT-4K operation—specifically the input/output requirements and the internal wiring needed to move results between TPU execution blocks, matching the compute bandwidth and input/output bandwidth.

FIG. 18 illustrates a transport overview for the 3-Tile FFT implementation discussed above. The three tiles are arranged as three horizontal rows. Each row includes 16 TPU pipeline elements, a phase shift block (part of the NLINX block for each TPU element), a transpose buffer element {B1, B2, B3}, and two additional buffer elements {B0, C2} for the first and second row. In the depicted example, the transport BW between all blocks is 128 B/cycle (64 INT16/cycle) and each set of 16 TPU elements per tile includes four SWMD channels, for a total of 64 channels per tile. The signal name for each transport bundle is shown above it {X0, X1, U0, U1, U2, V0, V1, V2, V3, YT, Y}.

FIG. 19 illustrates exemplary sequencing of an FFT-4K operation for a 3-Tile implementation. The timing scale for the horizontal axis is 512 cycles per major division. Each transport bundle moves 64 KB in this interval (=512 cycle*128 B/cycle). Each individual FFT-4K operation has 16 KB of data (=4Ksample*4 B/sample). Four independent sets of FFT-4K samples are processed in parallel, with a new bundle of four accepted every 512 cycles. The execution interval is 128 cycles/FFT-4K (=512 cycles/4*FFT-4K).

Each of the four transpose buffer elements {B0, B1, B2, B3} includes 64 2 KB channels, yielding a total capacity of 512 KB (=4*64*2 KB) and a total bandwidth of 1024 B/cycle (=4*64*4 B/cycle). This is 1/12th the L2 memory capacity and 5× the BW of the L2 memory resources of the 3 Tiles-implementation aspects discussed in further detail below described in a later section.

Each tile reads a transpose buffer to obtain the TPU operand stream and writes the TPU result stream into a different transpose, thus effecting a pipeline that is approximately 2560 cycles (5×512 cycles) in length (including input and output transport time). The C2 block is a special transport buffer that uses a Winograd Z-to-Y conversion block (described in further detail below), adding a small amount of pipeline latency (˜16 cycles or 0.6%) to the 2560 cycles above not visible at the Figure-19 timing scale. The TPU unload operation adds a similar amount of pipeline latency to each of the three stages {U,V,Y}—a latency that does not impact the pipeline throughput.

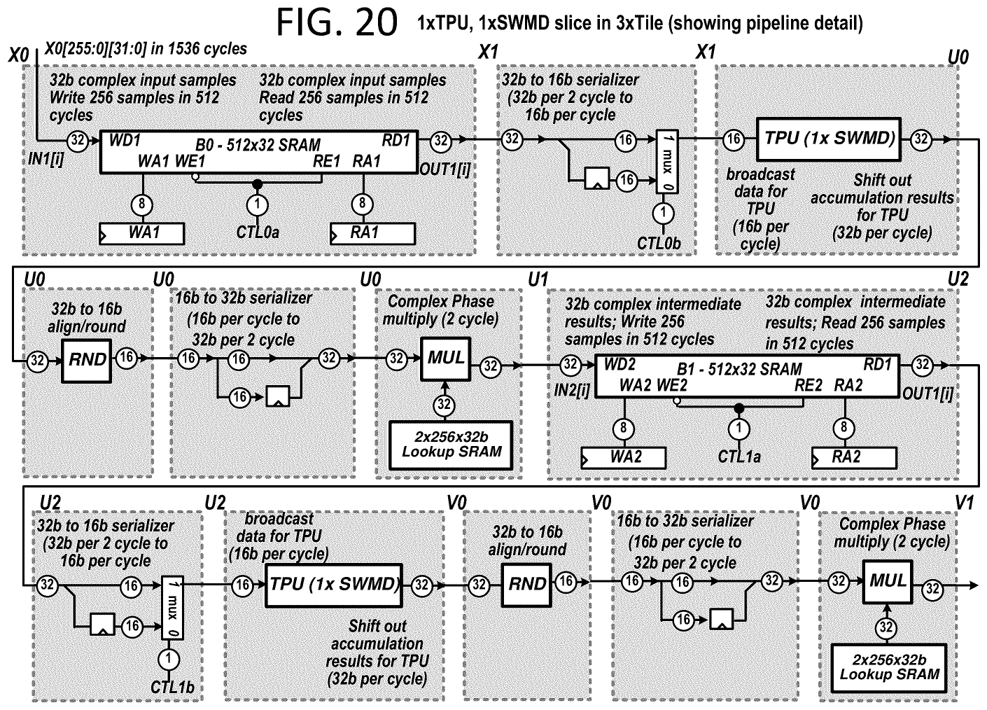

FIG. 20 illustrates exemplary transport detail for the 3-Tile implementation discussed above. In one embodiment, the three tiles are arranged as six horizontal rows, with FIG. 20 showing the first three of those six rows for single one of the 64 TPU/SWMD channels. The first row begins with reception of 256×0 input samples within the B0 transpose buffer in the first 512 cycle interval. These samples X1 are read out (transposed) in the next 512 cycle interval, serialized from 32 b every other cycle to 16 b every cycle, and then fed into the first TPU (stage U).

The second of the three transport-detail rows shown in FIG. 20 commences with streaming the 256 U0 output results in the second 512 cycle interval through the 32 b-to-16 b converter (align/round) element. The U0 results are deserialized from 16 b every cycle to 32 b every other cycle, multiplied by a phase shift constant, and then fed (as U1) into the second transpose buffer B1.

The third transport-detail row shown in FIG. 20 begins by reading out this U2 data (transposed) in the third 512 cycle interval. U2 is also serialized from 32 b every other cycle to 16 b every cycle and then fed into the second TPU (stage V). The 256 V0 output results are streamed out in the next 512 cycle interval through the 32 b-to-16 b converter (align/round) element. The V0 results are deserialized from 16 b every cycle to 32 b every other cycle and then multiplied by a phase shift constant to produce V1.

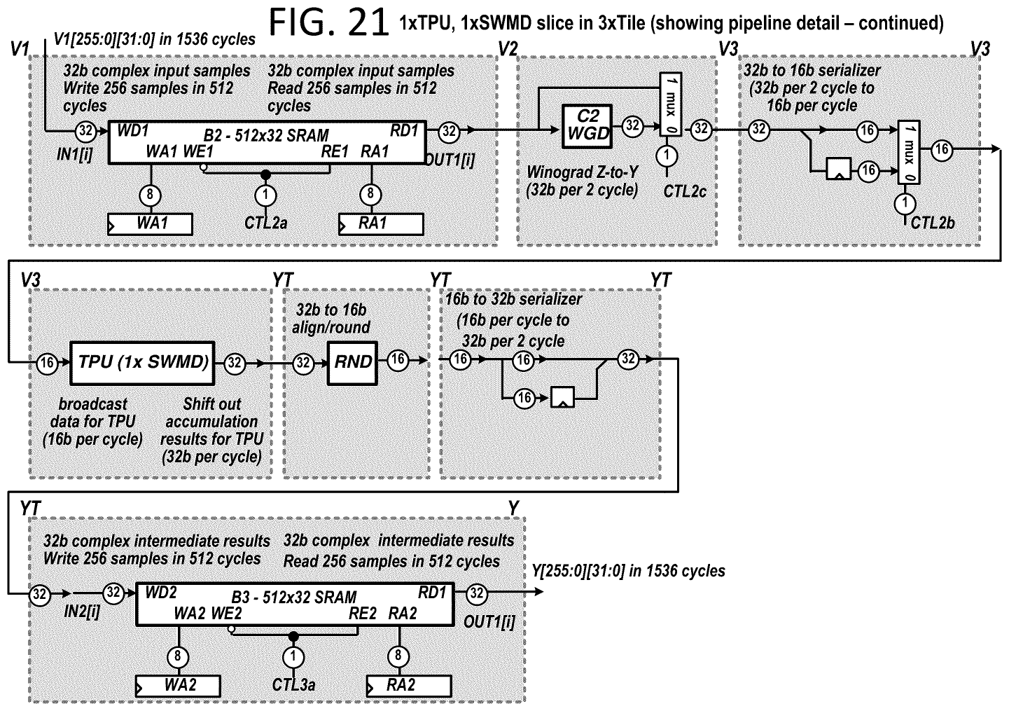

FIG. 21 illustrates rows four to six (the latter three) of the six transport-detail rows (i.e., forming, together with the three rows shown in FIG. 20, the six-horizontal-row arrangement of the three tiles). In the depicted example, the fourth row (first row shown in FIG. 21) begins by receiving 256 V1 data within the B2 transpose buffer in the third 512 cycle interval to produce data V2. V2 is read out (transposed) in the fourth 512-cycle interval and streamed through the C2 transpose buffer (with a small pipeline delay) to become V3. V3 are serialized from 32 b every other cycle to 16 b every cycle and then fed into the third TPU (stage Y).

The fifth transport-detail row (second row shown in FIG. 21) begins by feeding the V3 data into the third TPU (stage Y). The resulting YT data (transposed) is read out in the fourth 512 cycle interval (256 YT), streamed through the 32 b-to-16 b converter (align/round) element and deserialized from 16 b every cycle to 32 b every other cycle. The sixth and final transport-detail row (third row shown in FIG. 21) receives 256 YT data within the B3 transpose buffer in the fifth 512-cycle interval. The resulting data Y is read out (transposed) in the sixth 512-cycle interval.

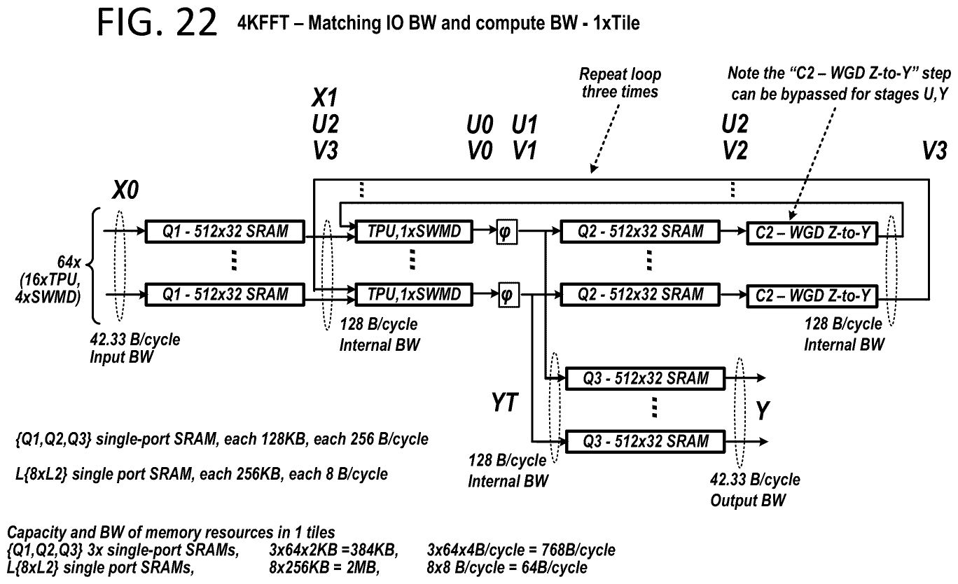

FIG. 22 illustrates an exemplary transport overview for the 1-Tile implementation discussed above, showing how compute and I/O bandwidth are matched. In the depicted example, a single tile is used during three ˜512-cycle intervals to perform the stage {U,V,Y} operations. In addition, three transpose buffers {Q1, Q2, and Q3} are applied to manage input, output and intermediate transport during the three stages, and a C2 special-transpose buffer applied to implement stage V.

In the FIG. 22 example, each of the 16 TPU elements in the tile includes four SWMD channels for a total of 64 channels per tile, effecting a 128 B/cycle (64 INT16/cycle) transport bandwidth (BW) between all blocks, with exceptions for the input and output bundles. The input and output bundles have a transport BW of 42.33 B/cycle (21.167 INT16/cycle) as the ˜1536-cycle execution time (for four parallel FFT-4K) is not a ˜512 cycle pipelined stage as in the 3-tile implementation. The signal name for each transport bundle is shown above the corresponding bundle in FIG. 22 (i.e., {X0, X1, U0, U1, U2, V0, V1, V2, V3, YT, Y}). Note that some of the transport bundles carry two or three different signals depending upon which stage is being processed. For example, the input operand contains the {X1, U2, V3} bundle for stage {U,V,Y}, respectively.

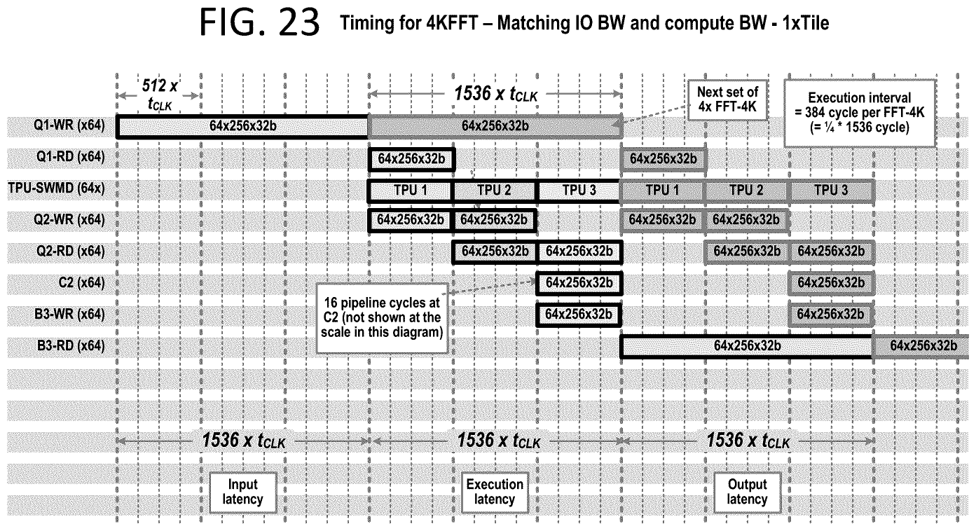

FIG. 23 illustrates exemplary sequencing of an FFT-4K operation for the 1-Tile implementation. The timing scale for the horizontal axis is 512 cycles per major division with each internal transport bundle moving 64 KB in this interval (=512 cycle*128 B/cycle). The input and output transport bundles run at one-third of this bandwidth. Each individual FFT-4K operation has 16 KB of data (=4Ksample*4 B/sample). Four independent sets of FFT-4K samples are processed in parallel, with a new bundle of four accepted every 3*512 cycles. The execution interval is ˜3*128 cycles/FFT-4K (=3*512 cycles/4*FFT-4K).

Still referring to FIG. 23, each of the four transpose buffer elements {Q1, Q2, Q3, C2} has 64 channels, effecting a total capacity of 512 KB (=4*64*2 KB) and a total BW of 1024 B/cycle (=4*64*4 B/cycle)− 1/12th the L2 memory capacity and 5× the BW of the L2 memory resources of the 3 Tiles in one embodiment (resources described in further detail below). The execution tile reads the Q1 or Q2 transpose buffer for the TPU operand stream and writes the Q2 or Q3 transpose buffer. The C2 transpose buffer and the TPU unload operation add ˜7% latency to execution time-a latency that will impact the pipeline throughput by about this same overhead (i.e. four parallel FFT-4K operations can be performed every ˜1700 cycles).

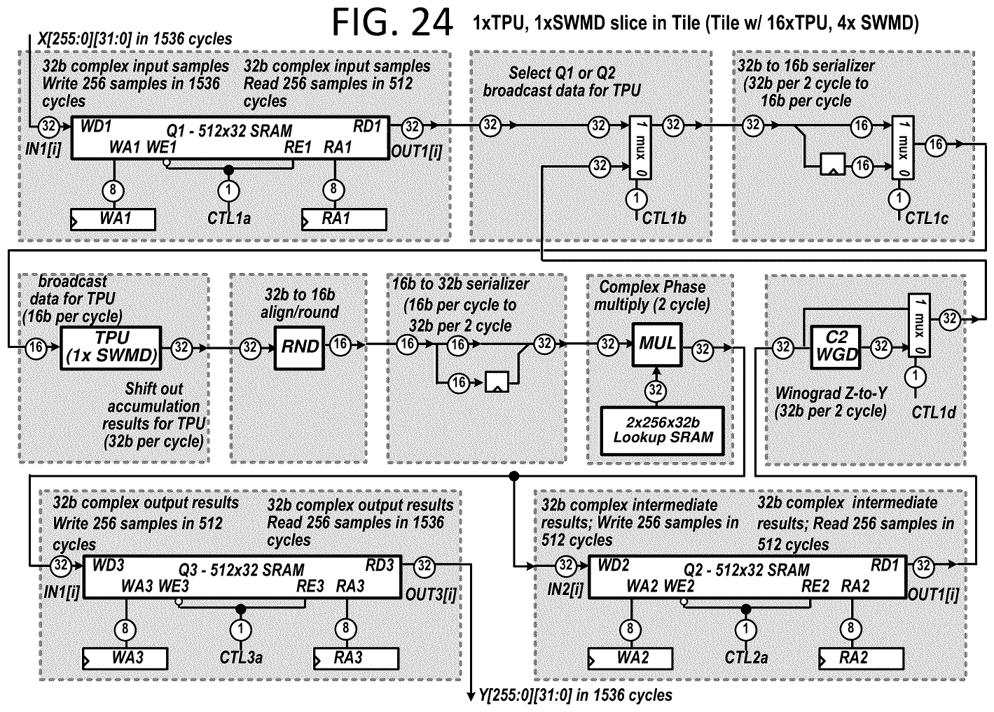

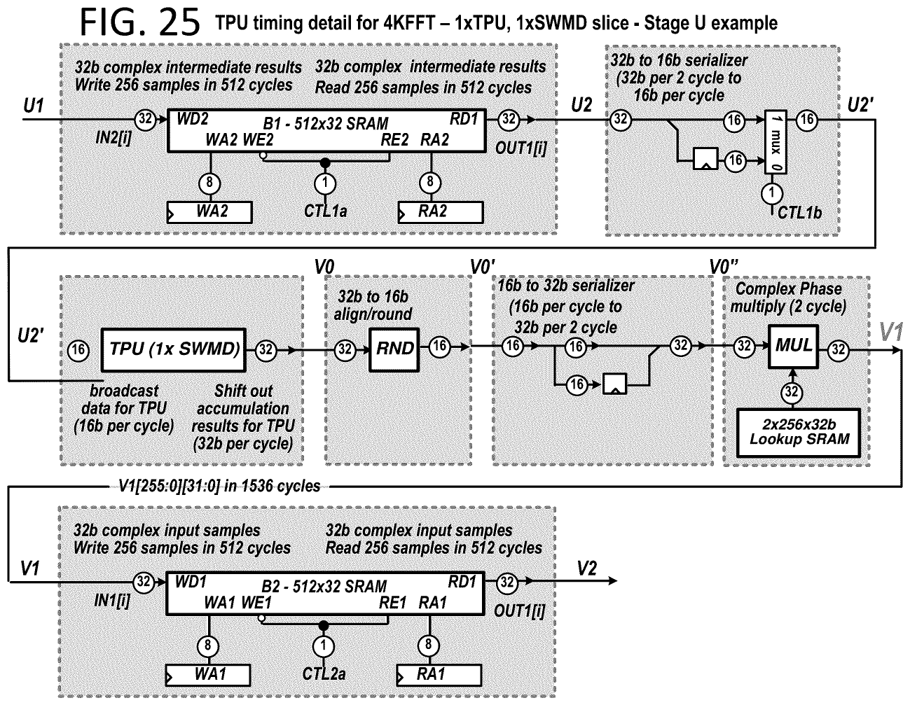

FIG. 24 illustrates exemplary transport detail for the 1-Tile implementation discussed above. The elements are arranged as three horizontal rows showing a single one of the 64 TPU/SWMD channels. In the depicted example, the first transport-detail row begins with reception of 256×0 input samples within the Q1 transpose buffer in the first 1536 cycle interval. These samples X1 are read out (transposed) in the next 512-cycle interval, serialized from 32 b every other cycle to 16 b every cycle, and then fed into the TPU (stage U).

Still referring to FIG. 24, the second transport-detail row begins by streaming the 256 U0 output results in the second 512-cycle interval through a 32 b-to-16 b converter (align/round) element. The U0 results are deserialized from 16 b every cycle to 32 b every other cycle, multiplied by a phase shift constant, and then fed (as U1) into the second transpose buffer Q2—this will be repeated during two more 512-cycle intervals to process stages {V, Y}. After stage V, the C2 transpose buffer is applied and after stage Y, the result will be stored in the Q3 transpose buffer for output (transposed) as Y [255:0][31:0] over a ˜1536-cycle interval.

FIG. 25 illustrates exemplary transport path detail for the sub-operations of FFT Stage U, commencing with reading out the B1 transpose memory (recall that B1 was previously written as U1 in the Input stage), yielding a 32 bit complex output value U2 (INT16 real, INT16 imaginary pair) in alternate cycles for approximately 512 cycles. The two 16 b components of each sequential complex value are serialized into a continuous stream U2′ of INT16 values and are passed as operands to a TPU/SWMD broadcast channel.

Still referring to FIG. 25, the TPU performs a series of sixteen 32-cycle accumulations, generating a stream of sixteen blocks each with 32 INT32 accumulation totals, V0. The INT32 V0 output values (which have a 32-cycle pipeline delay relative to input blocks U2′) are aligned/rounded to INT16 values V0′, deserialized to a 32-bit complex value (pairs of INT16 values) V0″ in alternating cycles, and then multiplied by a complex phase shift value to produce 32-bit complex value (pairs of INT16 values) V1 in alternating cycles. The V1 values are written to the B2 transpose buffer for eventual readout as output V2.

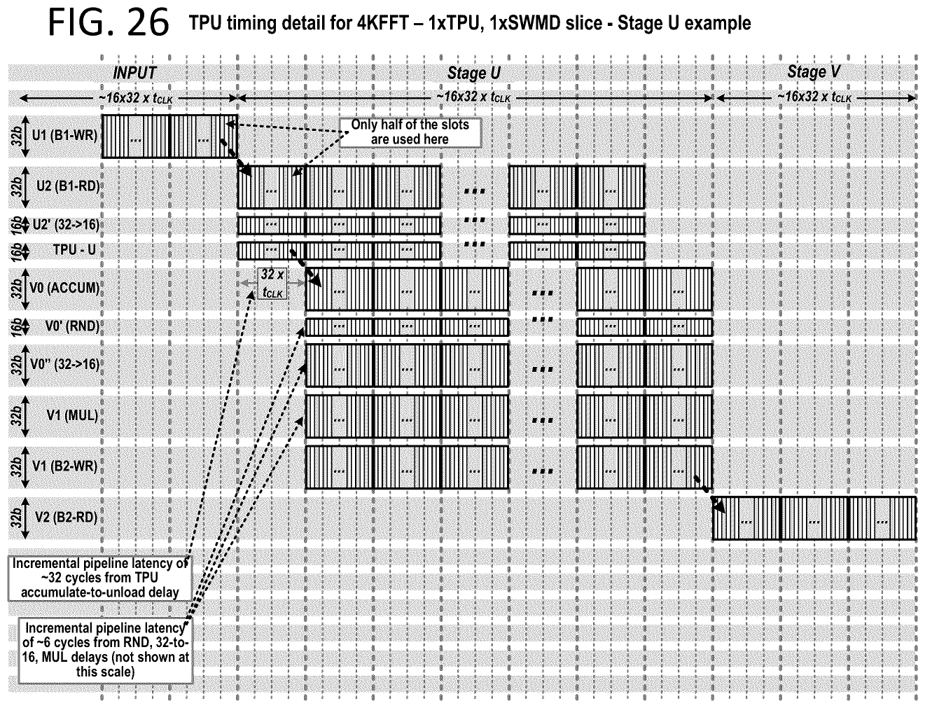

FIG. 26 illustrates exemplary timing detail for the sub-operations of Stage U, beginning with read-out of the B1 transpose memory (B1 was previously written as U1 in the Input stage). A 32 bit complex value U2 (INT16 real, INT16 imaginary pair) is read out in alternate cycles for approximately 512 cycles (16 groups of 32 cycles), with each INT16 pair serialized into a continuous stream U2′ of INT16 values which are passed, in turn, as operands to a TPU/SWMD broadcast channel.

Continuing with FIG. 26, the TPU performs a series of sixteen 32-cycle accumulations, generating a stream of sixteen blocks, each with 32 INT32 accumulation totals V0. The INT32 output values V0 (which have a 32-cycle pipeline delay relative to the input blocks U2′) are aligned/rounded to INT16 values V0′ and deserialized to a 32-bit complex value (pairs of INT16 values) V0″ in alternating cycles. These alternating complex values V0″ are multiplied by a complex phase shift value to produce, in alternating cycles, 32-bit complex value (pairs of INT16 values) V1 that are written to the B2 transpose buffer. While small additional pipeline delays on the order of a few cycles (too brief to appear in the Figure-26 time scale) are incurred by the align/round (RND) block, 16 b-to-32 b deserializer block and complex phase shift multiplication block (MUL) will increase the overall pipeline latency, the additional pipeline delays will not impact pipeline throughput in the 3-tile implementation.

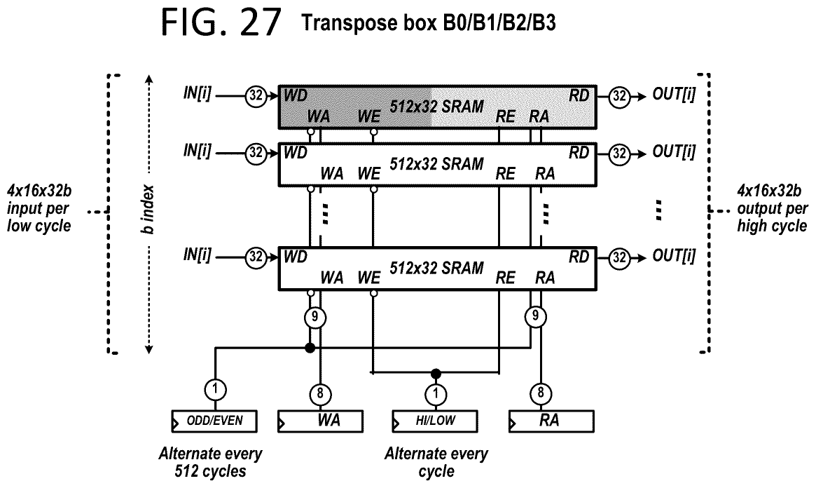

FIG. 27 illustrates an exemplary implementation of a transpose box applied to adjust the order of the streaming data. In a number of embodiments, the L2 memory available to each tile has inadequate BW (˜64 B/cycle per tile) to support data re-ordering so, instead, a small amount of SRAM memory is incorporated into the NLINX steering logic (i.e., TPU component) to provide the supplemental storage bandwidth needed to enable this re-ordering operation (˜256 B/cycle per tile). In the example shown, the per-tile storage capacity of the transpose box is approximately 1/16th of the per-tile L2 capacity.

Continuing with FIG. 27, a SRAM block (dark-shading for WR accesses and lighter-shading for RD accesses) is applied for one SWMD channel of one TPU. One tile will employ 4×16 of these two blocks for the 4×SWMD channels per each of the ×16 TPUs (e.g., 64 SRAM blocks in all), with those 64 SRAMs operated in parallel with a shared read address RA, shared write address WA, shared control “ODD/EVEN” and shared control “HI/LOW”.

The SRAM block is read and written in alternate cycles (e.g., by toggling HI/LOW control from cycle to cycle). During a subsequent 512-cycle interval, the upper 256 SRAM locations are written, and the low 256 SRAM locations are read. In each cycle of the 512-cycle interval, each SRAM accesses one ×32 b word (either read or write) so that, in the complete 512-cycle interval, 256×32 b words are read from the single SRAM and broadcast by one SWMD channel of one TPU, and 256×32 b words are received from one SWMD shift-out channel of one TPU read and written to the single SRAM.

Still referring to FIG. 27, each 32 b word (read from or written to the SRAM block) contains a 16 b real value and a 16 b imaginary value. The 256×32 b words that are read in each 512 cycle interval are broadcast at the rate of 16 b per cycle. Likewise, the 256×32 b words that are written in each 512 cycle interval are received from the shift-out bus at the rate of 16 b per cycle.

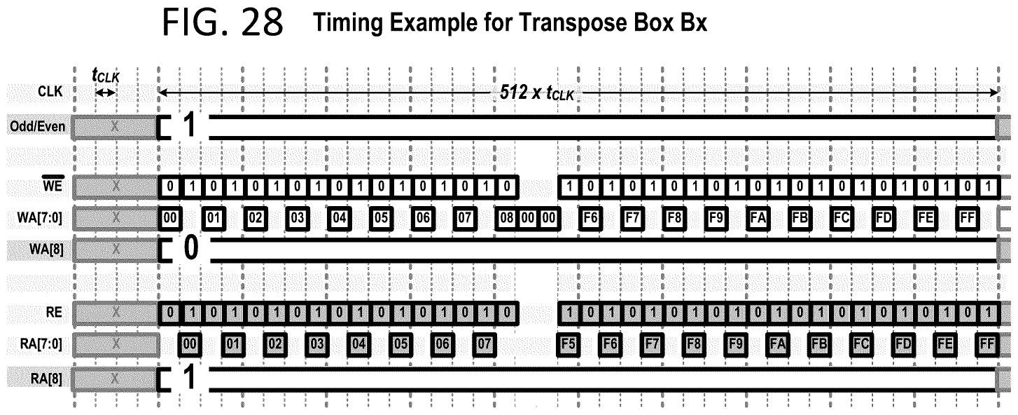

FIG. 28 illustrates exemplary timing for the write/read-alternated SRAM block shown in FIG. 27 (dark-shading for WR accesses and light-shading for RD accesses for one SWMD channel of one TPU). One tile will require 4×16 of these two blocks for the 4×SWMD channels per each of the ×16 TPUs, with the 64 SRAM blocks operated in parallel with a shared read address RA, shared write address WA, shared control “ODD/EVEN”, and shared control “HI/LOW”.

As discussed, the SRAM is read and written in alternate cycles (controlled by toggling HI/LOW from high to low on every cycle), with the HI/LOW control signal determining the high order address bits RA[8] and WA[8] for the read and write accesses. During a first 512-cycle interval (top, with ODD/EVEN=0), lower SRAM is written and upper SRAM is read. During the next 512-cycle interval (bottom, with ODD/EVEN=1), upper SRAM is written and lower SRAM is read.

In the FIG. 28 example, lower SRAM (unshaded) is written in normal ascending order and upper SRAM (shaded) is also written in normal ascending order. The read RA and write WA addresses can be independently specified, so other re-ordering options are possible. The example shown is adequate for the FFT-4K operation.

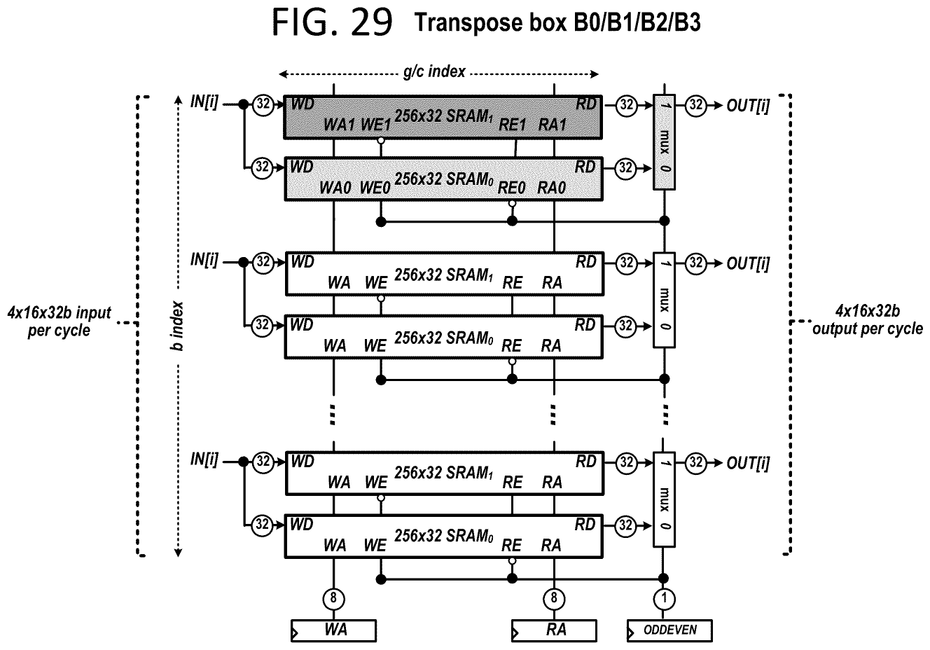

FIG. 29 illustrates an embodiment of another transpose box used to adjust the order of the streaming data. In embodiments for which the L2 memory BW available to each tile (˜64 B/cycle per tile) is insufficient to support data re-ordering, a small amount of SRAM memory is incorporated into the NLINX steering logic (i.e., TPU component) to provide the supplemental storage bandwidth needed to enable this re-ordering operation (˜512 B/cycle per tile). In the example shown, the per-tile storage capacity of the transpose box is approximately 1/16th of the per-tile L2 capacity.

FIG. 29 highlights the two SRAM blocks (SRAM0, light-shaded; SRAM1, dark-shaded) applied for each SWMD channel per TPU-one tile will require 4×16 of these two blocks for the 4×SWMD channels per each of the ×16 TPUs. These 64 SRAM pairs are operated in parallel with a shared read address RA, shared write address WA, and shared control “ODD/EVEN”.

During an initial 512-cycle interval, SRAM1 is written and SRAM0 is read. During the next 512-cycle interval, SRAM0 is written and SRAM1 is read. In each cycle of the 512-cycle interval, each SRAM accesses one ×32 b word (either read or write) so that, over the entire 512-cycle interval, 256×16 b words are read from the one SRAM and broadcast by one SWMD channel of one TPU, and 256×16 b words are received from one SWMD channel of one TPU (read) and written to the other SRAM.

Still referring to FIG. 29, each 32 b word (read or written from the SRAM pair) contains a 16 b real value and a 16 b imaginary value. The 256×32 b words that are read in each 512-cycle interval are broadcast at the rate of 16 b per cycle. Likewise, the 256×32 b words that are written in each 512 cycle interval are received from the shift-out bus at the rate of 16 b per cycle.

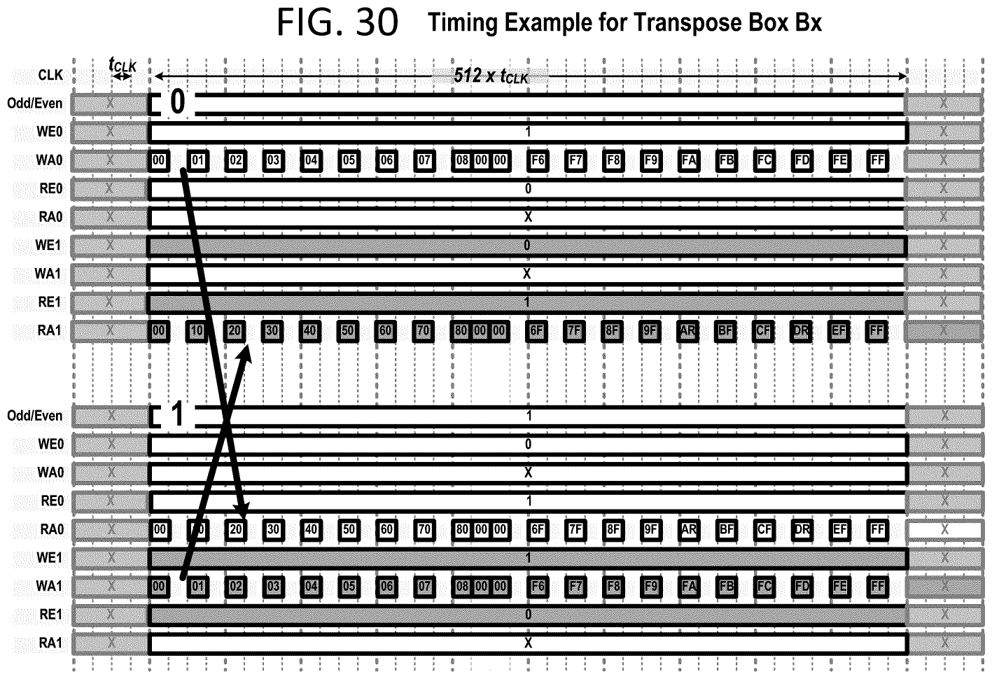

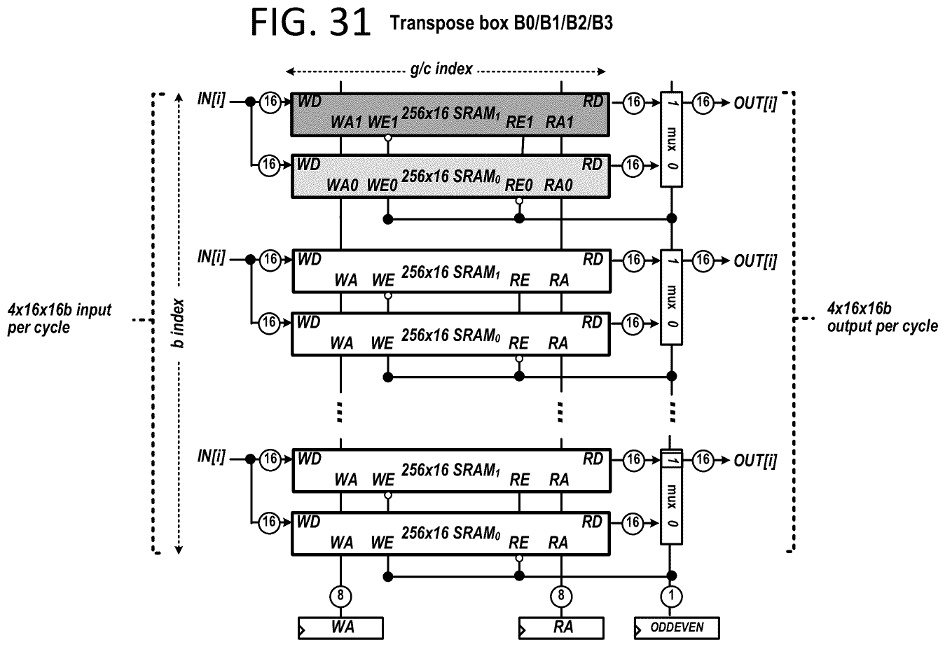

FIG. 30 illustrates exemplary timing for the two SRAM blocks (SRAM0, SRAM1) discussed above (i.e., applied in each SWMD channel of each TPU). As discussed, one tile will employ 4×16 of these two SRAM blocks (one such pair for each of the 4×SWMD channels per each of the ×16 TPUs) and the 64 SRAM pairs will be operated in parallel, with a shared read address RA, shared write address WA, and shared control “ODD/EVEN”.

As shown, during an initial 256-cycle interval (top, with ODD/EVEN=0), SRAM1 is written and SRAM0 is read and during the subsequent 256-cycle interval (bottom, with ODD/EVEN=1), SRAM1 is written and SRAM0 is read. In the depicted example, SRAM0 (unshaded) is written in normal ascending order, and is read in transpose ascending order, and SRAM1 (shaded) is also written in normal ascending order and is read in transpose ascending order. The read RA and write WA addresses can be independently specified, so other re-ordering options are possible. The example shown meets bandwidth requirements of the FFT-4K operation.

FIG. 31 illustrates an embodiment of the B0/B1/B2/B3 transpose box used to adjust the order of the streaming data. In embodiments for which the L2 memory BW available to each tile (˜64 B/cycle per tile) is insufficient to support data re-ordering, a small amount of SRAM memory is incorporated into the NLINX steering logic (i.e., TPU component) to provide the supplemental storage bandwidth needed to enable this re-ordering operation (˜256 B/cycle per tile). In the example shown, the per-tile storage capacity of the transpose box is approximately 1/16th of the per-tile L2 capacity.

As in embodiments above, FIG. 31 highlights the two SRAM blocks (SRAM0 light-shaded and SRAM1 dark-shaded) applied per SWMD channel of a given TPU-one tile will require 4×16 of these two blocks for the 4×SWMD channels per each of the ×16 TPUs. These 64 SRAM pairs are operated in parallel with a shared read address RA, shared write address WA, and shared control “ODD/EVEN”.

During an initial 256-cycle interval, SRAM1 is written and SRAM0 is read. During the next 256-cycle interval, SRAM0 is written and SRAM1 is read. In each cycle of each 256-cycle interval, each SRAM accesses one x16 b word (either read or write) so that, over the entire 256-cycle interval, 256×16 b words are read from the one SRAM and broadcast by one SWMD channel of one TPU, and 256×16 b words are received from one SWMD channel of one TPU (read) and written to the other SRAM.

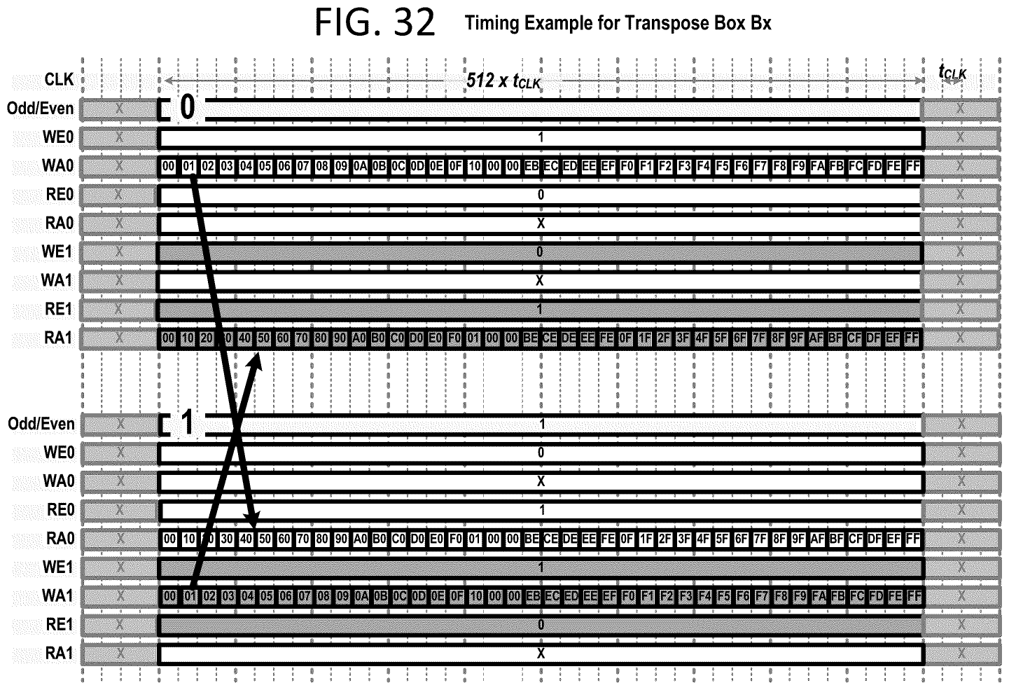

FIG. 32 illustrates exemplary timing for the two per-SWMD-channel, per-TPU SRAM blocks shown in FIG. 31 (i.e., SRAM0, SRAM1). As discussed, one tile will employ 4×16 of these two-SRAM blocks (one SRAM pair for each of the 4×SWMD channels per each of the ×16 TPUs) and the 64 SRAM pairs will be operated in parallel, with a shared read address RA, shared write address WA, and shared control “ODD/EVEN”.

As shown, during a first 256-cycle interval (top, with ODD/EVEN=0), SRAM1 is written and SRAM0 is read, and during the subsequent 256-cycle interval (bottom, with ODD/EVEN=1), SRAM1 is written and SRAM0 is read. In the depicted example, SRAM0 (accesses shown without shading) is written in normal ascending order and read in transpose ascending order, and SRAM1 (accesses shown with shading) is also written in normal ascending order and read in transpose ascending order. The read RA and write WA addresses can be independently specified, so other re-ordering options are possible. The example shown meets bandwidth requirements of the FFT-4K operation.

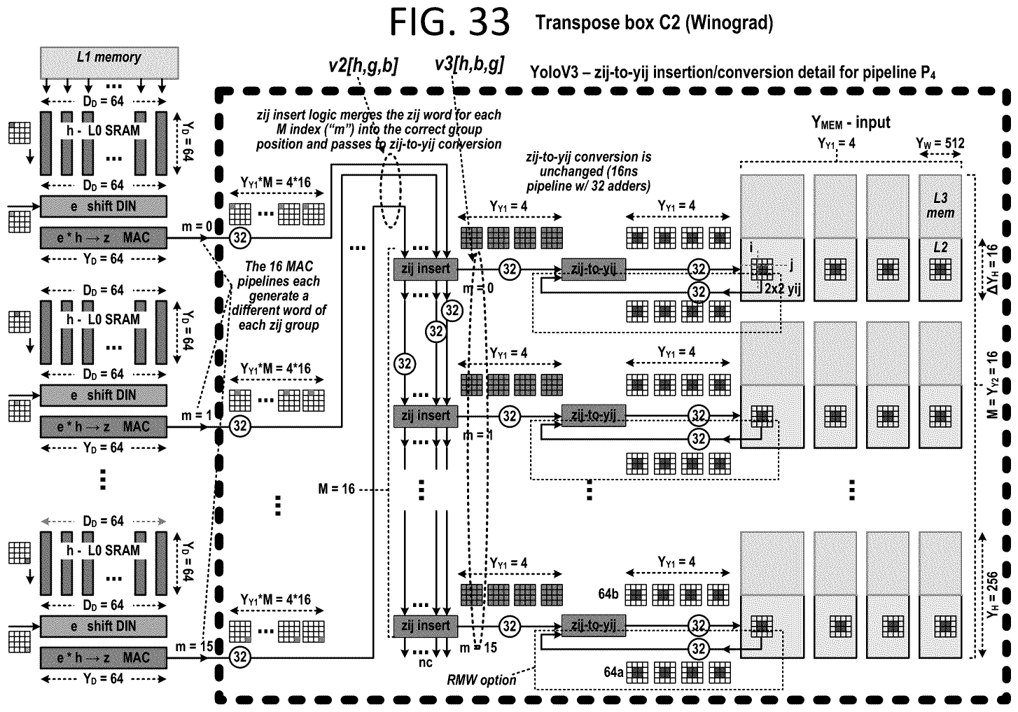

FIG. 33 illustrates an exemplary architecture of the Winograd (WGD) Z-to-Y conversion box, showing data/operand movement with respect to one of four SWMD channels in each the 16 per-tile TPUs (identical circuitry is implemented for the other three SWMD channels, enabling all four SWMD channels to be processed in parallel. The architecture can be modified slightly to operate as the C2 transpose box for FFT-4K operations.

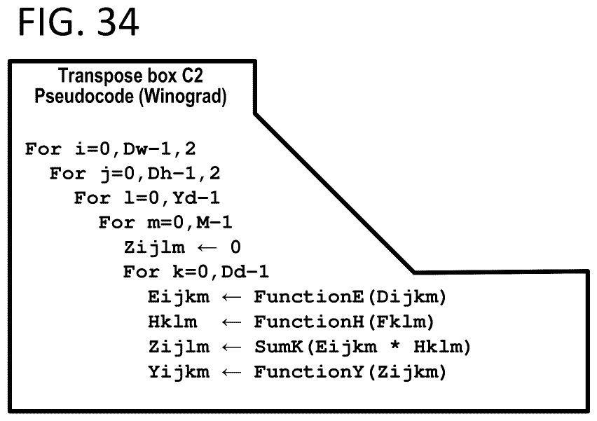

The Z-to-Y conversion box accepts sixteen 32 b values from the sixteen shift-out buses of the sixteen TPUs. In the case of FFT-4K, these 32 b values are a real INT16 and an imaginary INT16 (in the case of a WGD conversion, the 32 b values are INT32). The sixteen 32 b values are inserted into the top edge of the Z-to-Y conversion box. Over sixteen cycles, 256 32 b values are inserted and, in the ensuing 16 cycles, an orthogonal set of 16 buses (running horizontally in FIG. 33) extract those 256 32 b values, effecting the {b,g} transpose of the 256 values. The WGD Z-to-Y conversion box has been modified so that no arithmetic operations are performed on the 256 32 b values as they pass through the two sets of orthogonal buses. FIG. 34 presents an exemplary pseudocode listing corresponding to the Winograd Z-to-Y conversion box shown in FIG. 33, showing five nested loops implemented by the hardware set to carry out the conversion. Note that a read-modify-write (RMW) option may be employed when the input layer depth DD is larger than the pipeline depth. For this option the previously-written Yij group (four words labeled “64a” in FIG. 33) is read and passed to the accumulator input of the zij-to-yij converter to be added to the four words for the “64 b” operation. This operation may be timeshared (i.e., executed concurrently) the yij groups being written as only eight L2 memory cycles are needed out of each 16 (four Yij write and four Yij read).

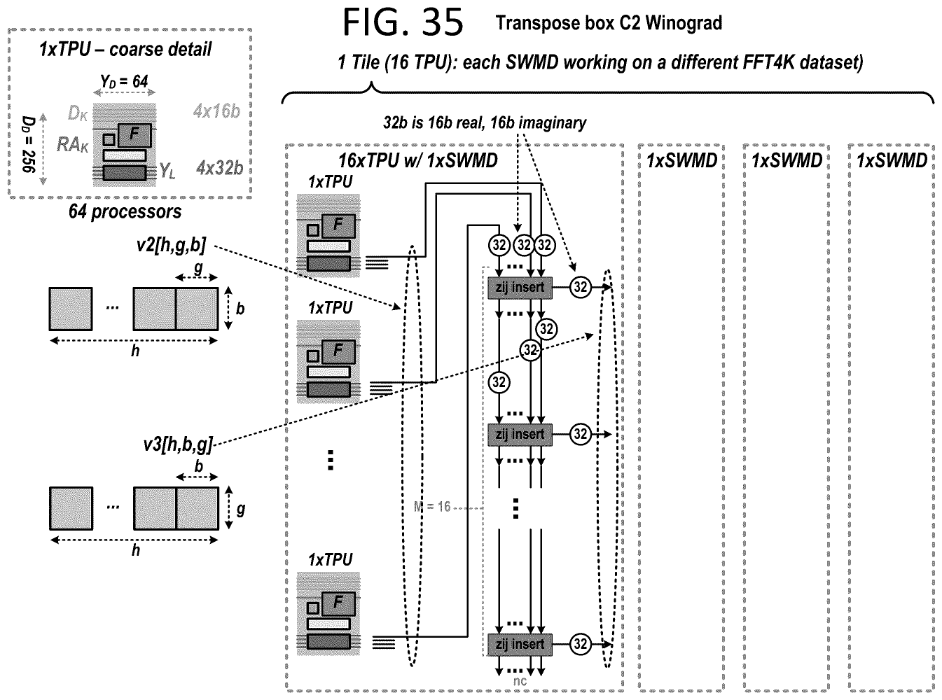

FIG. 35 illustrates another exemplary architecture for the Winograd (WGD) Z-to-Y conversion box which, like the embodiment of FIG. 33, can be operated (with minor modifications) as the C2 transpose box for FFT-4K operations.

FIG. 35 shows exemplary data movement for four SWMD channels within each of the 16 TPUs per tile. Identically implemented circuitry enables all four SWMD channels to be processed in parallel.

The call-outs emphasize insertion points for the 256 32 b input values (v2[h,g,b]) and extraction points for the 256 32 b output values (v3[h,b,g]). Note that the {g,b} indexes are transposed during this operation and also that the {h} index will be constant at one of sixteen values for the operation on the 256 32 b values. The depicted transpose operation will be repeated sixteen times, for each {h} index value.

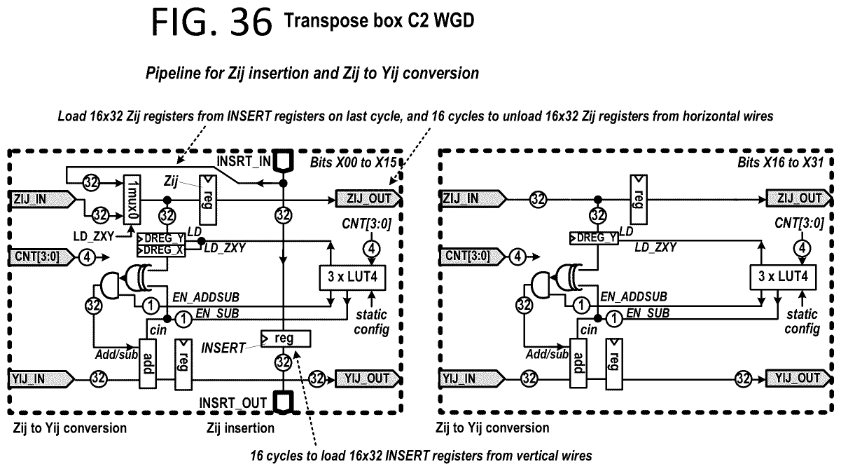

FIG. 36 illustrates additional detail with respect to a C2 transpose box embodiment. As shown, the Z-to-Y conversion box accepts sixteen 32 b values from the sixteen shift-out buses of the sixteen TPUs. In the case of FFT-4K, these 32 b values are a real INT16 and an imaginary INT16 (in the case of a WGD conversion, the 32 b values are INT32). The sixteen 32 b values are inserted into the top edge of the Z-to-Y conversion box (the INSRT_IN port). In sixteen cycles 256 32 b values are inserted. There are held in the register element designated “INSERT.” Upon insertion of all 256 of the 32 b values, those values are transferred in one cycle to the 256 “Zij” register elements. In the ensuing 16 cycles an orthogonal set of 16 buses (running horizontally, the ZIJ_OUT port) extract the 256 32 b values, effecting the {b,g} transpose of the 256 values. In the depicted embodiment, the WGD Z-to-Y conversion box is modified so that no arithmetic operations are performed on the 256 32 b values as they pass through the two sets of orthogonal buses.

The various embodiments presented herein include numerous innovative features including, for example and without limitation, those enumerated below:
[1] Method and/or computing circuitry which includes a linear array of processing elements (i.e., “linear array” or “linear processing array”) in which:
   each processing element includes a multiply-accumulate execution unit;
   each processing element includes 0th memory for current 1st operand (L0);
   each processing element includes a register for shared current 2nd operand;
   each processing element includes a register for current result; and/or
   each processing element executes a multiply-accumulate (MAC) sub-operation that includes multiplying 1st current operand by shared current 2nd operand and accumulating in current result.
[1a] The method and/or computing circuitry of [1] wherein:
   the linear processing array performs a series of MAC sub-operations to generate a Discrete-Fourier-Transform (DFT-N1) of N1 input samples; and/or
   a quantity N2 of the DFT-N1 operations are aggregated to generate a DFT-N result, where N=N1*N2.
[1b] The method and/or computing circuitry of [1a] in which (DFT-N with N2 DFT-N1):
   N1 equal to N\hat{ }(1/Q);
   N2 equal to Q*N\hat{ }(1−1/Q); and/or
   number of MAC sub-operations for method is N1*N1*N2=(Q*N*N\hat{ }(1/Q)), with DFT-N requiring (N\hat{ }2) MAC sub-operations, ‘\hat{ }’ denoting exponentiation.
[1c] The method and/or computing circuitry of [1b] in which:
   Q=3, N=4096;
   N1 equal to N\hat{ }(⅓)=16;
   N2 equal to 3*N\hat{ }(⅔)=3*256; and/or
   number of MAC sub-operations for method is (3*N*N\hat{ }(⅓)), with DFT-N requiring (N\hat{ }2) MAC sub-operations.
[1d] The method and/or computing circuitry of [1a] in which:
   the series of MAC sub-operations performed by the linear array is equivalent to a vector-matrix multiply operation;
   vector size is N1 elements; and/or
   matrix size is N1*N1 elements.
[1e] The method and/or computing circuitry of [1d] in which the element size can be configured between at least two numeric precisions.
[1f] The method and/or computing circuitry of [1d] in which the element size can be configured between a real value and a complex value (two real values).
[1g] The method and/or computing circuitry of [1d] in which the number of N1 input samples for the DFT-N1 operation matches the vector size of the linear array.
[1h] The method and/or computing circuitry of [1d] in which the vector size of the linear array can be configured between at least two different sizes.
[2] The method and/or computing circuitry of [1a] in which at least two linear arrays each perform a different subset of the N2 DFT-N1 operations which generate a DFT-N result.
[2a] The method and/or computing circuitry of [1c] in which, in a single tile implementation:
   at least two of the linear processing arrays each perform a different subset of the N2 DFT-N1 operations which generate a DFT-N result;
   N is equal to 4096;
   N1 is equal to N\hat{ }(⅓)=16;
   N2 is equal to 1*N\hat{ }(1−⅓)=256; and/or.
   There are 64 linear arrays, and each array performs twelve of the DFT-N1 operations.
[2b] The method and/or computing circuitry of [1c] in which, in a three-tile implementation:
   at least two of the linear processing arrays each perform a different subset of the N2 DFT-N1 operations which generate a DFT-N result;
   N is equal to 4096;
   N1 is equal to N\hat{ }(⅓)=16;
   N2 is equal to 3*N\hat{ }(1−⅓)=768; and/or.
   There are 192 linear arrays, and each array performs four of the DFT-N1 operations.
[3] The method and/or computing circuitry of [1a] in which:
   the linear array performs a first of the N2 DFT-N1 operations on a first set of N1 samples, producing a first set of N1 results during a first execution interval;
   a phase rotation operation is performed on the first set of N1 results by a first phase rotation element;
   the phase-rotated results are transposed with other sets of results in a first transpose buffer element; and/or
   this produces a first set of N1 phase-rotated, transposed results.
[3a] The method and/or computing circuitry of [3] in which, in a single-tile implementation:
   this first set of N1 phase-rotated, transposed results, are used as N1 samples by the linear array during a second execution interval; and/or
   the first linear array operates on data for the same DFT-N operation during the first and second execution intervals.
[3b] The method and/or computing circuitry of [1c] in which, in a three-tile implementation:
   this first set of N1 phase-rotated, transposed results, are used as N1 samples by a second linear array; and/or
   the first linear array and the second linear array operate concurrently on data for different DFT-N operations.
[3c] The method and/or computing circuitry of [3] in which the linear array includes a serial output bus, which allows the first set of N1 results to be unloaded after the first execution interval.
[3d] Method and/or computing circuitry of [3c] in which the first phase rotation element connects to a path that includes the serial output bus of the linear array.
[3e] The method and/or computing circuitry of [3c] in which a first transpose buffer element connects to a path that includes the serial output bus of the linear array.
[4a] The method and/or computing circuitry of [1] in which:
   the linear processing array performs a series of MAC sub-operations to generate a Discrete-Fourier-Transform (DFT-N1) of N1 input samples; and/or
   N2/N3 of the DFT-N1 operations are aggregated to generate a DFT-N′ result, where N′=N1*N2/N3.
[4b] The method and/or computing circuitry of [4a] in which a linear processing array concurrently performs N3 of the DFT-N′ operations
[4c] The method and/or computing circuitry of [1b] in which:
   Q=3, N=4096;
   N1 equal to N\hat{ }(⅓)=16;
   N2 equal to 3*N\hat{ }(⅔)/2=3*128;
   N3=2;
   N′=2048; and/or
   number of MAC sub-operations for N′ method is (3*N*N\hat{ }(⅓)), same as for N method.
[4d] The method and/or computing circuitry of [1b] in which:
   Q=3, N=4096;
   N1 equal to N\hat{ }(⅓)=16;
   N2 equal to 3*N\hat{ }(⅔)/2=3*128;
   N3={4, 8, 16};
   N′={1024, 512, 256}; and/or
   number of MAC sub-operations for N′ method is (3*N*N\hat{ }(⅓)), same as for N method
[4e] The method and/or computing circuitry of [4b] in which:
   the linear processing array performs a first of the N2 DFT-N1 operations on a first set of N1 samples, producing a first set of N1 results during a first execution interval;
   a phase rotation operation is performed on the first set of N1 results by a first phase rotation element;
   the phase-rotated results are transposed with other sets of results in a first transpose buffer element; and/or
   this produces a first set of N1 phase-rotated, transposed results.
[4f] The method and/or computing circuitry of [4e] in which the phase rotation operation for the DFT-N′ operation is different than the phase rotation operation for the DFT-N operation.
[4f] The method and/or computing circuitry of [4e] in which the transpose operation for the DFT-N′ operation is different than the transpose operation for the DFT-N operation.
[5a] The method and/or computing circuitry of [3] in which:
   a transpose buffer element is implemented as a single port memory;
   the memory width accommodates two data values;
   the memory cycle time is the same as the execution cycle time of a processing element;
   the memory alternates between read and write cycles;
   one set of memory addresses is written with new data values while old data values are read from the other set of memory addresses; and/or
   the read/write assignment of the two sets of memory addresses is switched after each set of DFT-N1 operations.
[5b] The method and/or computing circuitry of [3] in which:
   the transpose buffer element is implemented as two banks of a single port memory;
   the memory width accommodates one data value;
   the memory cycle time is the same as the execution cycle time of a processing element;
   one memory bank is written with new data values while old data values are read from the other memory bank; and/or
   the read/write assignment is switched after each set of DFT-N1 operations.
[5c] The method and/or computing circuitry of [3] in which:
   the transpose buffer element is implemented two sets of “bxb” stage pipeline register;
   one register set is written with new data values while old data values are read from the other register set; and/or
   the read/write assignment is switched after each set of DFT-N1 operations.
[5d] The method and/or computing circuitry of [3] in which:
   the transpose buffer element is implemented as “b” copies of a “b” stage insertion pipeline register;
   “b” copies of a “b” stage extraction pipeline register, with the insertion and extraction wires oriented in orthogonal directions;
   the memory cycle time is the same as the execution cycle time of a processing element;
   in every group of “b” cycles, the bxb insertion registers are written with new data values; and/or
   concurrently, in every group of “b” cycles, old data values are read from the bxb extraction registers.

Referring to FIGS. 1A-36 generally, the exemplary FFT architectures, tensor processing units (TPUs), memory/register elements, transpose boxes, data paths, MAC processors, signaling interfaces, interconnection paths, etc. may vary in numerous details and in particular with regard to any specific numbers, dimensions, formats, time-intervals presented (quantities of tiles, quantities of TPUs, quantities MAC processors, quantities of broadcast data channels, quantities of MAC channels, quantities of transpose boxes, shift-in/shift-out paths, bit depths, memory sizes, data formats, data precisions, matrix/array dimensions, tensor dimensions, sub-tensor dimensions, clock periods or frequencies, etc.). Moreover, the various embodiments (and component circuits thereof) presented herein may be implemented within a standalone integrated circuit component or IC package, or within one or more IC components (including packages having multiple IC dies) that combines the FFT-processing and/or matrix-multiply functionality thereof with one or more other functions (e.g., integrated-circuit processor, application-specific integrated circuit (ASIC), etc.). One or more programmed microcontrollers and/or dedicated hardware circuits (e.g., finite state machines, registered or combinational circuits, etc.) may implement and/or control all or part of the various architectural and functional circuit blocks within the integrated-circuit components presented herein. Additionally, any or all of those architectural/functional elements (or circuit blocks) may be described using computer aided design tools and expressed (or represented), as data and/or instructions embodied in various computer-readable media, in terms of their behavioral, register transfer, logic component, transistor, layout geometries, and/or other characteristics. Formats of files and other objects in which such circuit expressions may be implemented include, but are not limited to, formats supporting behavioral languages such as C, Verilog, and VHDL, formats supporting register level description languages like RTL, and formats supporting geometry description languages such as GDSII, GDSIII, GDSIV, CIF, MEBES and any other suitable formats and languages. Computer-readable media in which such formatted data and/or instructions may be embodied include, but are not limited to, computer storage media in various forms (e.g., optical, magnetic or semiconductor storage media).

When received within a computer system via one or more computer-readable media, such data and/or instruction-based expressions of the above described circuits and circuitry can be processed by a processing entity (e.g., one or more processors) within the computer system in conjunction with execution of one or more other computer programs including, without limitation, net-list generation programs, place and route programs and the like, to generate a representation or image of a physical manifestation of such circuits. Such representation or image can thereafter be used in device fabrication, for example, by enabling generation of one or more masks that are used to form various components of the circuits in a device fabrication process.

In the foregoing description and in the accompanying drawings, specific terminology and drawing symbols have been set forth to provide a thorough understanding of the disclosed embodiments. In some instances, the terminology and symbols may imply specific details not required to practice those embodiments. For example, the various functional-element quantities (tiles, TPUs per tile, MAC processors per TPU, transposes boxes, etc.), bit depths, memory sizes, tensor/matrix/sub-tensor dimensions, clock frequencies, data formats (including input data, operand data and output data), and so forth are provided for purposes of example only—any practicable alternatives may be implemented in all cases. Similarly, physical signaling interfaces (PHYs) having any practicable link parameters, protocols and configurations may be implemented in accordance with any practicable open or proprietary standard and any version of such standard. Links or other interconnections between integrated circuit devices and/or internal circuit elements or blocks may be shown as buses or as single signal lines. Each of the buses can alternatively be a single signal line, and each of the single signal lines can alternatively be a bus. Signals and signaling links, however shown or described, can be single-ended or differential. Logic signals shown or described as having active-high assertion or “true” states, may have opposite assertion states in alternative implementations. A signal driving circuit is said to “output” a signal to a signal receiving circuit when the signal driving circuit asserts (or de-asserts, if explicitly stated or indicated by context) the signal on a signal line coupled between the signal driving and signal receiving circuits. The term “coupled” is used herein to express a direct connection as well as a connection through one or more intervening circuits or structures. Integrated circuit device or register “programming” can include, for example and without limitation, loading a control value into a configuration register or other storage circuit within the integrated circuit device in response to a host instruction (and thus controlling an operational aspect of the device and/or establishing a device configuration) or through a one-time programming operation (e.g., blowing fuses within a configuration circuit during device production), and/or connecting one or more selected pins or other contact structures of the device to reference voltage lines (also referred to as strapping) to establish a particular device configuration or operational aspect of the device. The terms “exemplary” and “embodiment” are used to express an example, not a preference or requirement. Also, the terms “may” and “can” are used interchangeably to denote optional (permissible) subject matter. The absence of either term should not be construed as meaning that a given feature or technique is required.

Various modifications and changes can be made to the embodiments presented herein without departing from the broader spirit and scope of the disclosure. For example, features or aspects of any of the embodiments can be applied in combination with any other of the embodiments or in place of counterpart features or aspects thereof. Accordingly, the specification and drawings are to be regarded in an illustrative rather than a restrictive sense.

What is claimed is:

1. A fast-Fourier-transform (FFT) integrated circuit device comprising:
broadcast data paths; and
a first plurality of multiply-accumulate (MAC) circuit pairs coupled in common to the broadcast data paths, each MAC circuit pair of the first plurality of MAC circuit pairs having component circuitry to:
receive imaginary and real components of a first shared complex data value conveyed respectively via the broadcast data paths during a first clock cycle and then receive imaginary and real components of a second shared complex data value conveyed respectively via the broadcast data paths during a second clock cycle;
multiply the first shared complex data value with a respective one of a first set of FFT parameters during the second clock cycle to generate a respective one of a first plurality of complex multiplication products and then multiply the second shared complex data value with a respective one of a second set of FFT parameters during a third clock cycle to generate a respective one of a second plurality of complex multiplication products; and
generate a partial FFT result by adding the respective one of the first plurality of complex multiplication products to a respective one of a plurality of complex product-accumulations during the third clock cycle and then adding the respective one of the second plurality of complex multiplication products to the plurality of complex product-accumulations during a fourth clock cycle.

2. The FFT integrated circuit device of claim 1 wherein the broadcast data paths comprise first and second broadcast data paths to convey the imaginary and real components, respectively, of the first and second shared complex data values.

3. The FFT integrated circuit device of claim 1 wherein the imaginary and real components of the first shared complex data value comprise respective signed-integer data values.

4. The FFT integrated circuit device of claim 1 wherein the component circuitry within each MAC circuit pair of the first plurality of MAC circuit pairs iteratively accumulates partial FFT results over a first processing interval to generate a first discrete Fourier transform (DFT) with respect to a first sequence of shared complex data values conveyed via the broadcast data paths, the first sequence of shared complex data values including the first shared complex data value and the second shared complex data value.

5. The FFT integrated circuit device of claim 4 wherein the component circuitry within each MAC circuit pair of the first plurality of MAC circuit pairs iteratively accumulates partial FFT results over a second processing interval to generate a second DFT with respect to a second sequence of shared complex data values conveyed via the broadcast data paths.

6. The FFT integrated circuit device of claim 5 further comprising circuitry to aggregate the first and second DFTs into a resultant DFT.

7. The FFT integrated circuit device of claim 4 wherein the plurality of complex product accumulations comprises a plurality of complex values having a first precision, the FFT integrated circuit device further comprising a second plurality of multiply-accumulate (MAC) circuits to generate accumulated values that correspond respectively to the plurality of complex product accumulations and extend the first precision thereof to a second, greater precision.

8. The FFT integrated circuit device of claim 1 further comprising output path circuitry to sequentially shift out constituent complex product accumulations of the plurality of complex product-accumulations in a complex product accumulation stream, the output path circuitry including transpose circuitry to reorder the constituent complex product accumulations within the complex product accumulation stream.

9. The FFT integrated circuit device of claim 1 further comprising output path circuitry to sequentially shift out constituent complex product accumulations of the plurality of complex product-accumulations in a complex product accumulation stream, the output path circuitry including phase rotation circuitry to implement a complex phase rotation with respect to the constituent complex product accumulations within the complex product accumulation stream.

10. The FFT integrated circuit device of claim 1 further comprising an operand memory circuit to output each FFT parameter of the first set of FFT parameters to a respective one of the MAC circuit pairs during the first clock cycle, and then output each FFT parameter of the second set of FFT parameters to the respective one of the MAC circuit pairs during the second clock cycle.

11. A method of operation within a fast-Fourier-transform (FFT) integrated circuit device, the method comprising:
loading imaginary and real components of a first shared complex data value into a plurality of multiply-accumulate (MAC) circuit pairs during a first clock cycle and then loading imaginary and real components of a second shared complex data value into the plurality of MAC circuit pairs during a second clock cycle; and
within each of the MAC circuit pairs:
multiplying the first shared complex data value with a respective one of a first set of FFT parameters during the second clock cycle to generate a respective one of a first plurality of complex multiplication products and then multiplying the second shared complex data value with a respective one of a second set of FFT parameters during a third clock cycle to generate a respective one of a second plurality of complex multiplication products; and
generating a partial FFT result by adding the respective one of the first plurality of complex multiplication products to a respective one of a plurality of complex product-accumulations during the third clock cycle and then adding the respective one of the second plurality of complex multiplication products to the plurality of complex product-accumulations during a fourth clock cycle.

12. The method of claim 11 wherein the broadcast data paths comprise first and second broadcast data paths to convey the imaginary and real components, respectively, of the first and second shared complex data values.

13. The method of claim 11 wherein the imaginary and real components of the first complex data value comprise respective signed-integer data values.

14. The method of claim 11 wherein each of the MAC circuit pairs iteratively accumulates partial FFT results over a first processing interval to generate a first discrete Fourier transform (DFT) with respect to a first sequence of shared complex data values conveyed via broadcast data paths, the first sequence of shared complex data values including the first shared complex data value and the second shared complex data value.

15. The method of claim 14 wherein each of the MAC circuit pairs iteratively accumulates partial FFT results over the first processing interval to generate a second DFT with respect to a second sequence of shared complex data values, the method further comprising aggregating the first and second DFTs into a resultant DFT.

16. The method of claim 14 wherein each of the MAC circuit pairs iteratively accumulates partial FFT results over a second processing interval to generate a second DFT with respect to a second sequence of shared data values, the method further comprising aggregating the first and second DFTs into a resultant DFT.

17. The method of claim 11 wherein the plurality of complex product accumulations comprises a plurality of complex values having a first precision, the method further comprising generating accumulated values that (i) correspond respectively to the plurality of complex product accumulations and (ii) extend the first precision thereof to a second, greater precision.

18. The method of claim 11 further comprising sequentially shifting out constituent complex product accumulations of the plurality of complex product-accumulations in a complex product accumulation stream, including applying transpose circuitry to reorder the constituent complex product accumulations within the complex product accumulation stream relative to order in which the constituent complex product accumulations are output from the plurality of MAC circuit pairs.

19. The method of claim 11 further comprising sequentially shifting out constituent complex product accumulations of the plurality of complex product-accumulations in a complex product accumulation stream, including applying phase rotation circuitry to implement a complex phase rotation with respect to the constituent complex product accumulations within the complex product accumulation stream.

20. The method of claim 11 further comprising outputting constituent FFT parameters of the first set of FFT parameters from an operand memory circuit to the MAC circuit pairs, respectively, during the first clock cycle, and then outputting constituent FFT parameters of the second set of FFT parameters from the operand memory circuit to the MAC circuit pairs, respectively, during the second clock cycle.

21. The method of claim 20 further comprising supplying a first address value to the operand memory to output the first set of FFT parameters from a first storage row within the operand memory circuit during the first clock cycle.

22. The method of claim 21 further comprising transitioning the first address value to a second address value during the second clock cycle, the second address value specifying a second storage row within the operand memory circuit containing the second set of FFT parameters such that the operand memory outputs each FFT parameter of the second set of FFT parameters to a respective one of the MAC circuit pairs during the second clock cycle.

23. A fast-Fourier-transform (FFT) integrated circuit device comprising:
broadcast data paths; and
a plurality of multiply-accumulate (MAC) circuit pairs coupled in common to the broadcast data paths, each MAC circuit pair of the plurality of MAC circuit pairs having:
means for receiving imaginary and real components of a first shared complex data value conveyed respectively via the broadcast data paths during a first clock cycle and then receiving imaginary and real components of a second shared complex data value conveyed respectively via the broadcast data paths during a second clock cycle;
means for multiplying the first shared complex data value with a respective one of a first set of FFT parameters during the second clock cycle to generate a respective one of a first plurality of complex multiplication products and then multiplying the second shared complex data value with a respective one of a second set of FFT parameters during a third clock cycle to generate a respective one of a second plurality of complex multiplication products; and
means for generating a partial FFT result by adding the respective one of the first plurality of complex multiplication products to a respective one of a plurality of complex product-accumulations during the third clock cycle and then adding the respective one of the second plurality of complex multiplication products to the plurality of complex product-accumulations during a fourth clock cycle.
